(19) United States
(12) Patent Application Publication
(10) Pub. No.: US 2026/0237330 A1
(43) Pub. Date: Aug. 13, 2026

(54) PIXEL CIRCUIT, TEST METHOD, DISPLAY PANEL, AND DISPLAY APPARATUS

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN); Beijing BOE Technology Development Co., Ltd., Beijing (CN)

(72) Inventors: Changlong YUAN, Beijing (CN); Li ZHU, Beijing (CN); Jingyi FENG, Beijing (CN); Zhenhua ZHANG, Beijing (CN); Xilei CAO, Beijing (CN); Wulin SHEN, Beijing (CN); Zhen LIU, Beijing (CN); Xiaoxiao WANG, Beijing (CN)

(21) Appl. No.: 19/107,509

(22) PCT Filed: May 23, 2024
(86) PCT No.: PCT/CN2024/094962

§ 371 Date: Feb. 27, 2025

(51) Int. Cl. G09G 3/00; G09G 3/3233

(52) U.S. Cl. CPC G09G 3/006; G09G 3/3233; G09G 2300/0819; G09G 2300/0852; G09G 2310/08; G09G 2330/12

(57) ABSTRACT

A pixel circuit, a test method, a display panel, and a display apparatus are provided. The pixel circuit includes a pixel driving circuit, a light-emitting element, and a test switch circuit; a control terminal of the test switch circuit is electrically connected to a test control terminal; the test switch circuit is disposed between a first test terminal and a second test terminal, and is used for controlling the first test terminal and the second test terminal to be connected or disconnected under control of a test control signal; the pixel driving circuit is electrically connected to the first test terminal, the second test terminal, and the light-emitting element, and is used for generating a drive current for driving the light-emitting element.

### CROSS-REFERENCE TO RELATED APPLICATION

The present application is a U.S. national phase application of a PCT Application No. PCT/CN2024/094962 filed on May 23, 2024, a disclosure of which is incorporated in its entirety by reference herein.

### TECHNICAL FIELD

The present disclosure relates to the field of display technologies, and in particular to a pixel circuit, a test method, a display panel, and a display apparatus.

### BACKGROUND

For a pixel circuit in a source follower form, a signal trace that provides a data voltage is electrically connected to a gate electrode of a driving transistor directly. During an array test (AT), the signal trace cannot sense a current flowing through the driving transistor. Therefore, special design and improvement are required when the AT needs to be performed on the pixel circuit.

### SUMMARY

In an aspect, the present disclosure provides in some embodiments a pixel circuit, including a pixel driving circuit, a light-emitting element, and a test switch circuit, where a control terminal of the test switch circuit is electrically connected to a test control terminal;
the test switch circuit is disposed between a first test terminal and a second test terminal, and is used for, under control of a test control signal provided by the test control terminal, controlling the first test terminal and the second test terminal to be connected or disconnected from each other;
the pixel driving circuit is electrically connected to the first test terminal, the second test terminal, and the light-emitting element, and is used for generating a drive current for driving the light-emitting element; and
the first test terminal is electrically connected to a first direct current voltage line, and the first test terminal is electrically connected to a second direct current voltage line or a test node; or the first test terminal is electrically connected to a direct current voltage line, and the second test terminal is electrically connected to a data line.

Optionally, the pixel driving circuit includes a driving circuit and a driving control circuit;
a control terminal of the driving circuit is electrically connected to a first node; a first terminal of the driving circuit is electrically connected to a first test node, a second terminal of the driving circuit is electrically connected to the light-emitting element, and the driving circuit is used for generating a drive current under control of a potential of the first node; and
the driving control circuit is used for controlling the control terminal of the driving circuit and the first terminal of the driving circuit to be connected to each other in response to the test switch circuit controlling the first test terminal and the second test terminal to be connected to each other.

Optionally, the first test terminal is electrically connected to a reference voltage line, and the second test terminal is electrically connected to a power voltage line; or the first test terminal is electrically connected to an initial voltage line, and the second test terminal is electrically connected to the data line; or the first test terminal is electrically connected to a reference voltage line, and the second test terminal is electrically connected to the first test node; or the first test terminal is electrically connected to an initial voltage line, and the second test terminal is electrically connected to a second test node.

Optionally, the test switch circuit includes a test switch transistor; and
a gate electrode of the test switch transistor is electrically connected to the test control terminal, a first electrode of the test switch transistor is electrically connected to the first test terminal, and a second electrode of the test switch transistor is electrically connected to the second test terminal.

Optionally, the driving control circuit includes a first light-emitting control circuit, a data write circuit, a first reset circuit, and a second reset circuit;
the first light-emitting control circuit is electrically connected to a first light-emitting control line, the power voltage line, and the first terminal of the driving circuit, and is used for, under control of a first light-emitting control signal provided by the first light-emitting control line, controlling the power voltage line and the first terminal of the driving circuit to be connected or disconnected from each other;
the data write circuit is electrically connected to a scan line, the data line, and a write node, and is used for, under control of a scan signal provided by the scan line, controlling the data line and the write node to be connected or disconnected from each other; the second test node is electrically connected to the write node; the write node is electrically connected to the first node;
the first reset circuit is electrically connected to a first reset control line, the reference voltage line, and the first node, and is used for, under control of a first reset control signal provided by the first reset control line, controlling the reference voltage line and the first node to be connected or disconnected from each other;
the second reset circuit is electrically connected to a second reset control line, the initial voltage line, and a reset node, and is used for, under control of a second reset control signal provided by the second reset control line, controlling the initial voltage line and the reset node to be connected or disconnected from each other; and the reset node is electrically connected to the second terminal of the driving circuit.

Optionally, the pixel circuit in at least one embodiment of the present disclosure further includes a first energy-storage circuit and a second energy-storage circuit,
where the first energy-storage circuit is electrically connected to the first node and the second terminal of the driving circuit, and is used for storing electric energy; and
the second energy-storage circuit is electrically connected to the power voltage line and the second terminal of the driving circuit, and is used for storing electric energy.

Optionally, the pixel circuit in at least one embodiment of the present disclosure further includes a first energy-storage circuit, a second energy-storage circuit, and a third reset circuit,
where the first energy-storage circuit is electrically connected to the write node and an intermediate node, and is used for storing electric energy;
the second energy-storage circuit is electrically connected to the intermediate node and the second terminal of the driving circuit, and is used for storing electric energy; and
the third reset circuit is electrically connected to a third reset control line, the reference voltage line, and the intermediate node, and is used for, under control of a third reset control signal provided by the third reset control line, controlling the reference voltage line and the intermediate node to be connected or disconnected from each other.

Optionally, the pixel circuit in at least one embodiment of the present disclosure further includes a switch control circuit,
where the first node is electrically connected to the write node through the switch control circuit; and
a control terminal of the switch control circuit is electrically connected to a switch control line, and the switch control circuit is used for, under control of a switch control signal provided by the switch control line, controlling the first node and the write node to be connected or disconnected from each other.

Optionally, the pixel circuit in at least one embodiment of the present disclosure further includes a second light-emitting control circuit,
where the reset node is electrically connected to the second terminal of the driving circuit through the second light-emitting control circuit; the reset node is electrically connected to a first electrode of the light-emitting element, and a second electrode of the light-emitting element is electrically connected to a low voltage line; and
a control terminal of the second light-emitting control circuit is electrically connected to a second light-emitting control line, and the second light-emitting control circuit is used for, under control of a second light-emitting control signal provided by the second light-emitting control line, controlling the reset node and the second terminal of the driving circuit to be connected or disconnected from each other.

Optionally, the driving circuit includes a driving transistor, the first light-emitting control circuit includes a first transistor, the data write circuit includes a second transistor, the first reset circuit includes a third transistor, and the second reset circuit includes a fourth transistor;
a gate electrode of the driving transistor is electrically connected to the first node, a first electrode of the driving transistor is electrically connected to the first test node, and a second electrode of the driving transistor is electrically connected to the light-emitting element;
a gate electrode of the first transistor is electrically connected to the first light-emitting control line, a first electrode of the first transistor is electrically connected to the power voltage line, and a second electrode of the first transistor is electrically connected to the first electrode of the driving transistor;
a gate electrode of the second transistor is electrically connected to the scan line, a first electrode of the second transistor is electrically connected to the data line, and a second electrode of the second transistor is electrically connected to the write node;
a gate electrode of the third transistor is electrically connected to the first reset control line, a first electrode of the third transistor is electrically connected to the reference voltage line, and a second electrode of the third transistor is electrically connected to the first node; and
a gate electrode of the fourth transistor is electrically connected to the second reset control line, a first electrode of the fourth transistor is electrically connected to the initial voltage line, and a second electrode of the fourth transistor is electrically connected to the reset node.

Optionally, the first energy-storage circuit includes a first capacitor, and the second energy-storage circuit includes a second capacitor;
a first terminal of the first capacitor is electrically connected to the first node, and a second terminal of the first capacitor is electrically connected to the second terminal of the driving circuit; and
a first terminal of the second capacitor is electrically connected to the power voltage line, and a second terminal of the second capacitor is electrically connected to the second terminal of the driving circuit.

Optionally, the first energy-storage circuit includes a first capacitor, and the second energy-storage circuit includes a second capacitor; the third reset circuit includes a fifth transistor;
a first terminal of the first capacitor is electrically connected to the write node, and a second terminal of the first capacitor is electrically connected to the intermediate node;
a first terminal of the second capacitor is electrically connected to the intermediate node, and a second terminal of the second capacitor is electrically connected to the second terminal of the driving circuit; and
a gate electrode of the fifth transistor is electrically connected to the third reset control line, a first electrode of the fifth transistor is electrically connected to the reference voltage line, and a second electrode of the fifth transistor is electrically connected to the intermediate node.

Optionally, the switch control circuit includes a sixth transistor; and
a gate electrode of the sixth transistor is electrically connected to the switch control line, a first electrode of the sixth transistor is electrically connected to the first node, and a second electrode of the sixth transistor is electrically connected to the write node.

Optionally, the second light-emitting control circuit includes a seventh transistor; and
a gate electrode of the seventh transistor is electrically connected to the second light-emitting control line, a first electrode of the seventh transistor is electrically connected to the second terminal of the driving circuit, and a second electrode of the seventh transistor is electrically connected to the reset node.

In a second aspect, the present disclosure provides in some embodiments a pixel circuit test method, applied to the foregoing pixel circuit, where the method includes:
in a detection phase, providing a valid test control signal to the test control terminal, and controlling, by the test switch circuit under control of the test control signal, the first test terminal and the second test terminal to be connected to each other.

Optionally, the method further includes:
in a display phase, providing an invalid test control signal to the test control terminal, controlling, by the test switch circuit under control of the test control signal, the first test terminal and the second test terminal to be disconnected from each other, and generating, by the pixel driving circuit, the drive current for driving the light-emitting element.

Optionally, the pixel driving circuit includes the driving circuit and a driving control circuit; and the method includes:
in the detection phase, controlling, by the driving control circuit, the control terminal of the driving circuit and the first terminal of the driving circuit to be connected to each other.

In a third aspect, the present disclosure provides in some embodiments a display apparatus, including the foregoing pixel circuit.

In a fourth aspect, the present disclosure provides in some embodiments a display panel, including pixel circuits in a plurality of rows and a plurality of columns, a plurality of first direct current voltage lines, and a plurality of second direct current voltage lines, where the pixel circuits are disposed in a display area; the display panel further includes a test switch module disposed in a bezel area; the test switch module includes a plurality of test switch circuits; and
each of the test switch circuits is electrically connected to a test control terminal, one of the first direct current voltage lines, and one of the second direct current voltage lines, and is used for, under control of a test control signal provided by the test control terminal, controlling the first direct current voltage line and the second direct current voltage line to be connected or disconnected from each other.

Optionally, the first direct current voltage lines and the second direct current voltage lines all extend in a first direction; the display panel includes N rows of pixel circuits; the pixel circuits located in an n^{th} row are electrically connected to an n^{th}first direct current voltage line of the first direct current voltage lines and an n^{th} second direct current voltage line of the second direct current voltage lines; N is an integer greater than 1, and n is a positive integer less than or equal to N;
the test switch module includes N test switch circuits; and
an n^{th} test switch circuit of the test switch circuits is electrically connected to an n^{th} test control terminal, the nth first direct current voltage line, and the n^{th} second direct current voltage line, and is used for, under control of an n^{th} test control signal provided by the n^{th} test control terminal, controlling the n^{th} first direct current voltage line and the n^{th} second direct current voltage line to be connected or disconnected from each other.

Optionally, the display panel in the embodiments of the present disclosure includes N rows of pixel circuits, where the pixel circuits located in an nth row are electrically connected to an nth first direct current voltage line of the first direct current voltage lines and an nth second direct current voltage line of the second direct current voltage lines; N is an integer greater than 1, and n is a positive integer less than or equal to N; m is a positive integer less than N;
the test switch module includes at least one test switch circuit; and
an m^{th} test switch circuit of the test switch circuits is electrically connected to an m^{th} test control terminal, an m^{th} first direct current voltage line of the first direct current voltage lines, and an (m+1)^{th} second direct current voltage line of the second direct current voltage lines, and is used for, under control of an m^{th} test control signal provided by the m^{th} test control terminal, controlling the m^{th} first direct current voltage line and the (m+1)^{th} second direct current voltage line to be connected or disconnected from each other.

Optionally, the first direct current voltage lines include a plurality of rows of first direct current voltage line portions and a plurality of columns of second direct current voltage line portions that are electrically connected to each other, and the second direct current voltage lines include a plurality of rows of third direct current voltage line portions and a plurality of columns of fourth direct current voltage line portions that are electrically connected to each other;
an extension direction of the first direct current voltage line portions is the same as an extension direction of the third direct current voltage line portions, an extension direction of the second direct current voltage line portions is the same as an extension direction of the fourth direct current voltage line portions, and the extension direction of the first direct current voltage line portions intersects the extension direction of the second direct current voltage line portions;
the test switch module includes a plurality of first test switch circuits and a plurality of second test switch circuits;
each of the first test switch circuits is electrically connected to a corresponding test control terminal, one row of the first direct current voltage line portions, and one row of the third direct current voltage line portions, and is used for, under control of the test control signal provided by the test control terminal, controlling the row of the first direct current voltage line portions and the row of the third direct current voltage line portions to be connected or disconnected from each other; and
each of the second test switch circuits is electrically connected to a corresponding test control terminal, one column of the second direct current voltage line portions, and one column of the fourth direct current voltage line portions, and is used for, under control of the test control signal provided by the test control terminal, controlling the column of the second direct current voltage line portions and the column of the fourth direct current voltage line portions to be connected or disconnected from each other.

In a fifth aspect, the present disclosure provides in some embodiments a display panel, including pixel circuits in a plurality of rows and A columns, a plurality of third direct current voltage lines, and data lines in A columns, where A is an integer greater than 1; a is a positive integer less than or equal to A; the pixel circuits are disposed in a display area; the pixel circuits located in an a^{th} column are electrically connected to the data line in the a^{th} column;
the display panel further includes a test switch module disposed in a bezel area; the test switch module includes A test switch circuits; and
an a^{th} test switch circuit of the test switch circuits is electrically connected to an a^{th} test control terminal, one of the third direct current voltage lines, and the data line in the a^{th} column, and is used for, under control of an a^{th} test control signal provided by the a^{th} test control terminal, controlling the third direct current voltage line and the data line in the a^{th} column to be connected or disconnected from each other.

In a sixth aspect, the present disclosure provides in some embodiments a display apparatus, including the foregoing display panel.

### BRIEF DESCRIPTION OF THE DRAWINGS

FIG. 1 is a structural diagram of a pixel circuit according to at least one embodiment of the present disclosure;

FIG. 2 is a structural diagram of a pixel circuit according to at least one embodiment of the present disclosure;

FIG. 3 is a structural diagram of a pixel circuit according to at least one embodiment of the present disclosure;

FIG. 4 is a structural diagram of a pixel circuit according to at least one embodiment of the present disclosure;

FIG. 5 is a structural diagram of a pixel circuit according to at least one embodiment of the present disclosure;

FIG. 6 is a structural diagram of a pixel circuit according to at least one embodiment of the present disclosure;

FIG. 7 is a structural diagram of a pixel circuit according to at least one embodiment of the present disclosure;

FIG. 8 is a structural diagram of a pixel circuit according to at least one embodiment of the present disclosure;

FIG. 9 is a circuit diagram of a pixel circuit according to at least one embodiment of the present disclosure;

FIG. 10A is an operating timing diagram of at least one embodiment of the pixel circuit shown in FIG. 9 according to the present disclosure;

FIG. 10B is a schematic diagram of a current path in a detection phase of at least one embodiment of the pixel circuit shown in FIG. 9 according to the present disclosure;

FIG. 11A is a circuit diagram of a pixel circuit according to at least one embodiment of the present disclosure;

FIG. 11B is a schematic diagram of a current path in a detection phase of at least one embodiment of the pixel circuit shown in FIG. 11A according to the present disclosure;

FIG. 12 is a circuit diagram of a pixel circuit according to at least one embodiment of the present disclosure;

FIG. 13A is an operating timing diagram of at least one embodiment of the pixel circuit shown in FIG. 12 according to the present disclosure;

FIG. 13B is a schematic diagram of a current path in a detection phase of at least one embodiment of the pixel circuit shown in FIG. 12 according to the present disclosure;

FIG. 14 is a circuit diagram of a pixel circuit according to at least one embodiment of the present disclosure;

FIG. 15A is an operating timing diagram of at least one embodiment of the pixel circuit shown in FIG. 14 according to the present disclosure;

FIG. 15B is a schematic diagram of a current path in a detection phase of at least one embodiment of the pixel circuit shown in FIG. 14 according to the present disclosure;

FIG. 16A is a circuit diagram of a pixel circuit according to at least one embodiment of the present disclosure;

FIG. 16B is a schematic diagram of a current path in a detection phase of at least one embodiment of the pixel circuit shown in FIG. 16A according to the present disclosure;

FIG. 17 is a circuit diagram of a pixel circuit according to at least one embodiment of the present disclosure;

FIG. 18A is a first operating timing diagram of at least one embodiment of the pixel circuit shown in FIG. 17 according to the present disclosure;

FIG. 18B is a first operating timing diagram of at least one embodiment of the pixel circuit shown in FIG. 17 according to the present disclosure;

FIG. 18C is a schematic diagram of a first current path in a detection phase of at least one embodiment of the pixel circuit shown in FIG. 17 according to the present disclosure;

FIG. 18D is a schematic diagram of a second current path in a detection phase of at least one embodiment of the pixel circuit shown in FIG. 17 according to the present disclosure;

FIG. 19 is a circuit diagram of a pixel circuit according to at least one embodiment of the present disclosure;

FIG. 20A is a first operating timing diagram of at least one embodiment of the pixel circuit shown in FIG. 19 according to the present disclosure;

FIG. 20B is a first operating timing diagram of at least one embodiment of the pixel circuit shown in FIG. 19 according to the present disclosure;

FIG. 20C is a schematic diagram of a first current path in a detection phase of at least one embodiment of the pixel circuit shown in FIG. 19 according to the present disclosure;

FIG. 20D is a schematic diagram of a second current path in a detection phase of at least one embodiment of the pixel circuit shown in FIG. 19 according to the present disclosure;

FIG. 21 is a structural diagram of a display panel according to at least one embodiment of the present disclosure;

FIG. 22 is a structural diagram of a display panel according to at least one embodiment of the present disclosure; and

FIG. 23 is a schematic diagram of pixel circuits located in a same column sharing one test switch transistor.

### DETAILED DESCRIPTION

The following clearly and completely describes the technical solutions in the embodiments of the present disclosure with reference to the accompanying drawings in the embodiments of the present disclosure. Apparently, the described embodiments are only some embodiments of the present disclosure rather than all the embodiments. All other embodiments obtained by persons of ordinary skill in the art based on the embodiments of the present disclosure without creative efforts fall within the scope of the present disclosure.

A transistor used in all the embodiments of the present disclosure may be a thin-film transistor, field-effect transistor or another device having the same characteristics. In some embodiments of the present disclosure, to distinguish between two electrodes other than a gate electrode of the transistor, one of the electrodes is referred to as a first electrode, and the other electrode is referred to as a second electrode.

During actual operations, when the transistor is a thin-film transistor or field-effect transistor, the first electrode may be a drain electrode, and the second electrode may be a source electrode; or the first electrode may be a source electrode, and the second electrode may be a drain electrode.

A pixel circuit according to embodiments of the present disclosure includes a pixel driving circuit, a light-emitting element, and a test switch circuit, where a control terminal of the test switch circuit is electrically connected to a test control terminal;
the test switch circuit is disposed between a first test terminal and a second test terminal, and is used for, under control of a test control signal provided by the test control terminal, controlling the first test terminal and the second test terminal to be connected or disconnected from each other;
the pixel driving circuit is electrically connected to the first test terminal, the second test terminal, and the light-emitting element, and is used for generating a drive current for driving the light-emitting element; and
the first test terminal is electrically connected to a first direct current voltage line, and the first test terminal is electrically connected to a second direct current voltage line or a test node; or the first test terminal is electrically connected to a direct current voltage line, and the second test terminal is electrically connected to a data line.

When the pixel circuit in the embodiments of the present disclosure operates, in a detection phase, the test switch circuit controls, under control of the test control signal, the first test terminal and the second test terminal to be connected to each other to form a current path, and the performance of transistors on the current path can be detected by detecting a current on the current path.

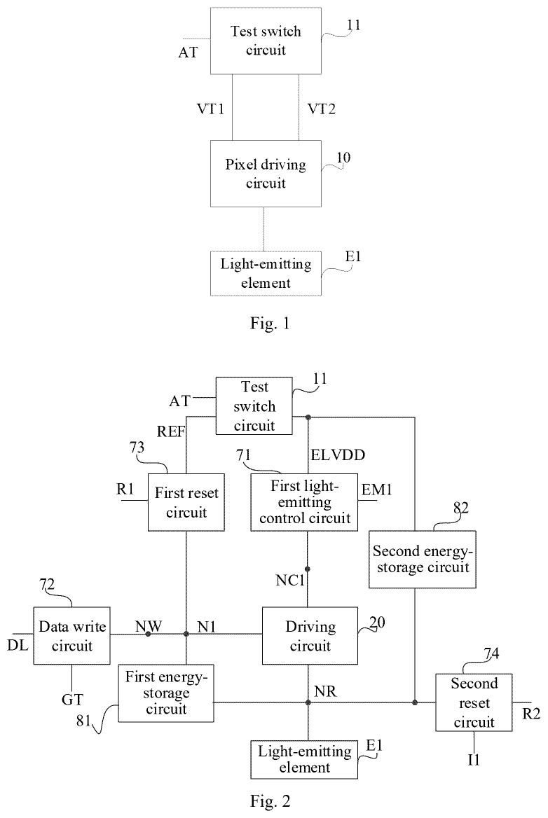

As shown in FIG. 1, a pixel circuit in at least one embodiment of the present disclosure includes a pixel driving circuit 10, a light-emitting element E1, and a test switch circuit 11. A control terminal of the test switch circuit 11 is electrically connected to a test control terminal AT;
the test switch circuit 11 is disposed between a first test terminal VT1 and a second test terminal VT2, and is used for, under control of a test control signal provided by the test control terminal AT, controlling the first test terminal VT1 and the second test terminal VT2 to be connected or disconnected from each other; and
the pixel driving circuit 10 is electrically connected to the first test terminal VT1, the second test terminal VT2, and the light-emitting element E1, and is used for generating a drive current for driving the light-emitting element E1.

In at least one embodiment of the present disclosure, the pixel driving circuit includes a driving circuit and a driving control circuit;
a control terminal of the driving circuit is electrically connected to a first node; a first terminal of the driving circuit is electrically connected to a first test node, a second terminal of the driving circuit is electrically connected to the light-emitting element, and the driving circuit is used for generating a drive current under control of a potential of the first node; and
the driving control circuit is used for controlling the control terminal of the driving circuit and the first terminal of the driving circuit to be connected to each other in response to the test switch circuit controlling the first test terminal and the second test terminal to be connected to each other.

During specific implementation, the pixel driving circuit may include a driving circuit and a driving control circuit. The driving control circuit controls the control terminal of the driving circuit and the first terminal of the driving circuit to be connected to each other in response to the test switch circuit controlling the first test terminal and the second test terminal to be connected to each other. A current flowing through the driving circuit is detected, and the performance of a driving transistor included in the driving circuit may be detected according to a detection result to perform an AT on the pixel circuit.

Optionally, the first test terminal is electrically connected to a reference voltage line, and the second test terminal is electrically connected to a power voltage line; or the first test terminal is electrically connected to an initial voltage line, and the second test terminal is electrically connected to the data line; or the first test terminal is electrically connected to a reference voltage line, and the second test terminal is electrically connected to the first test node; or the first test terminal is electrically connected to an initial voltage line, and the second test terminal is electrically connected to a second test node.

Optionally, the test switch circuit includes a test switch transistor; and
a gate electrode of the test switch transistor is electrically connected to the test control terminal, a first electrode of the test switch transistor is electrically connected to the first test terminal, and a second electrode of the test switch transistor is electrically connected to the second test terminal.

In at least one embodiment of the present disclosure, the driving control circuit includes a first light-emitting control circuit, a data write circuit, a first reset circuit, and a second reset circuit;
the first light-emitting control circuit is electrically connected to a first light-emitting control line, the power voltage line, and the first terminal of the driving circuit, and is used for, under control of a first light-emitting control signal provided by the first light-emitting control line, controlling the power voltage line and the first terminal of the driving circuit to be connected or disconnected from each other;
the data write circuit is electrically connected to a scan line, a data line, and a write node, and is used for, under control of a scan signal provided by the scan line, controlling the data line and the write node to be connected or disconnected from each other; the second test node is electrically connected to the write node; the write node is electrically connected to the first node;
the first reset circuit is electrically connected to a first reset control line, the reference voltage line, and the first node, and is used for, under control of a first reset control signal provided by the first reset control line, controlling the reference voltage line and the first node to be connected or disconnected from each other;
the second reset circuit is electrically connected to a second reset control line, the initial voltage line, and a reset node, and is used for, under control of a second reset control signal provided by the second reset control line, controlling the initial voltage line and the reset node to be connected or disconnected from each other; and the reset node is electrically connected to the second terminal of the driving circuit.

The pixel circuit in at least one embodiment of the present disclosure further includes a first energy-storage circuit and a second energy-storage circuit,
where the first energy-storage circuit is electrically connected to the first node and the second terminal of the driving circuit, and is used for storing electric energy; and
the second energy-storage circuit is electrically connected to the power voltage line and the second terminal of the driving circuit, and is used for storing electric energy.

As shown in FIG. 2, based on the at least one embodiment of the pixel circuit shown in FIG. 1, the first test terminal is electrically connected to a reference voltage line REF, and the second test terminal is electrically connected to a power voltage line ELVDD;
the pixel driving circuit includes a driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;
the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EMI, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other; and the write node NW is electrically connected to the first node N1;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and a reset node NR, and is used for, under control of a second reset control signal provided by the second reset control line R2, controlling the initial voltage line I1 and the reset node NR to be connected or disconnected from each other; and the reset node NR is electrically connected to the second terminal of the driving circuit 20;
the pixel circuit in at least one embodiment of the present disclosure further includes a first energy-storage circuit 81 and a second energy-storage circuit 82; the first energy-storage circuit 81 is electrically connected to the first node N1 and the second terminal of the driving circuit 20, and is used for storing electric energy; and
the second energy-storage circuit 82 is electrically connected to the power voltage line ELVDD and the second terminal of the driving circuit 20, and is used for storing electric energy.

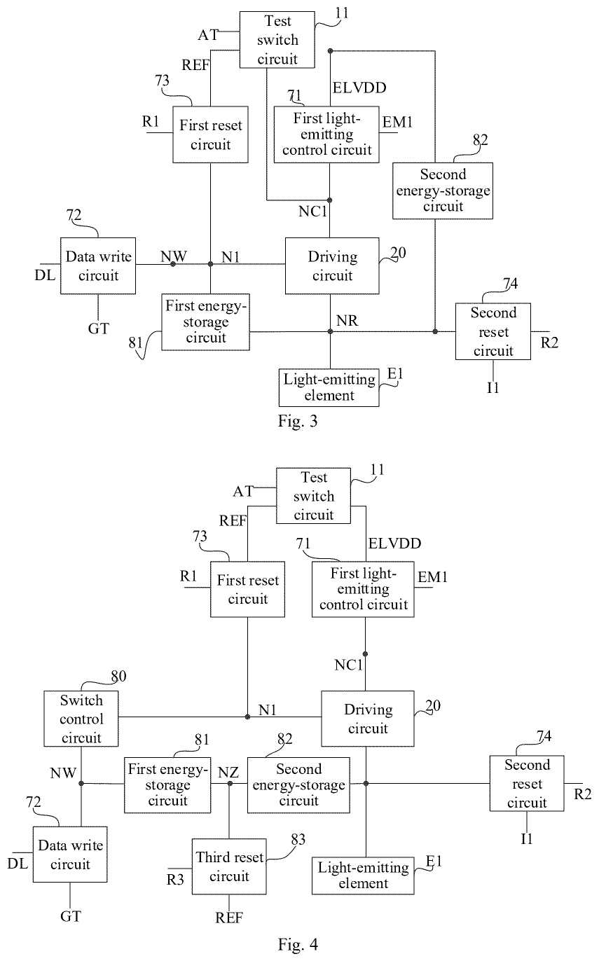

As shown in FIG. 3, based on the at least one embodiment of the pixel circuit shown in FIG. 1, the first test terminal is electrically connected to a reference voltage line REF, and the second test terminal is electrically connected to a first test node NC1;
the pixel driving circuit includes the driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;

the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EM1, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other; the write node NW is electrically connected to the first node N1;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and a reset node NR, and is used for, under control of a second reset control signal provided by the second reset control line R2, controlling the initial voltage line I1 and the reset node NR to be connected or disconnected from each other; the reset node NR is electrically connected to the second terminal of the driving circuit 20;
the pixel circuit in at least one embodiment of the present disclosure further includes a first energy-storage circuit 81 and a second energy-storage circuit 82; the first energy-storage circuit 81 is electrically connected to the first node N1 and the second terminal of the driving circuit 20, and is used for storing electric energy; and
the second energy-storage circuit 82 is electrically connected to the power voltage line ELVDD and the second terminal of the driving circuit 20, and is used for storing electric energy.

The pixel circuit in at least one embodiment of the present disclosure further includes a first energy-storage circuit, a second energy-storage circuit, and a third reset circuit,
where the first energy-storage circuit is electrically connected to the write node and an intermediate node, and is used for storing electric energy;
the second energy-storage circuit is electrically connected to the intermediate node and the second terminal of the driving circuit, and is used for storing electric energy; and
the third reset circuit is electrically connected to a third reset control line, the reference voltage line, and the intermediate node, and is used for, under control of a third reset control signal provided by the third reset control line, controlling the reference voltage line and the intermediate node to be connected or disconnected from each other.

The pixel circuit in at least one embodiment of the present disclosure further includes a switch control circuit; and
the first node is electrically connected to the write node through the switch control circuit; and
a control terminal of the switch control circuit is electrically connected to a switch control line, and the switch control circuit is used for, under control of a switch control signal provided by the switch control line, controlling the first node and the write node to be connected or disconnected from each other.

As shown in FIG. 4, based on the at least one embodiment of the pixel circuit shown in FIG. 1, the first test terminal is electrically connected to a reference voltage line REF, and the second test terminal is electrically connected to a power voltage line ELVDD;
the pixel driving circuit includes the driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;
the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EM1, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and the second terminal of the driving circuit 20, and is used for, under control of a second reset control signal provided by the second reset control line R2, controlling the initial voltage line I1 and the second terminal of the driving circuit 20 to be connected or disconnected from each other;
the pixel circuit in at least one embodiment of the present disclosure further includes a first energy-storage circuit 81, a second energy-storage circuit 82, and a third reset circuit 83;
the first energy-storage circuit 81 is electrically connected to the write node NW and an intermediate node NZ, and is used for storing electric energy;
the second energy-storage circuit 82 is electrically connected to the intermediate node NZ and the second terminal of the driving circuit 20, and is used for storing electric energy;
the third reset circuit 83 is electrically connected to a third reset control line R3, the reference voltage line REF, and the intermediate node NZ, and is used for, under control of a third reset control signal provided by the third reset control line R3, controlling the reference voltage line REF and the intermediate node NZ to be connected or disconnected from each other;
the pixel circuit in at least one embodiment of the present disclosure further includes a switch control circuit 80;
the first node N1 is electrically connected to the write node NW through the switch control circuit 80; and
a control terminal of the switch control circuit 80 is electrically connected to a switch control line SW, and the switch control circuit 80 is used for, under control of a switch control signal provided by the switch control line SW, controlling the first node N1 and the write node NW to be connected or disconnected from each other.

Optionally, the third reset control line may be the first reset control line, and the switch control line may be the second light-emitting control line.

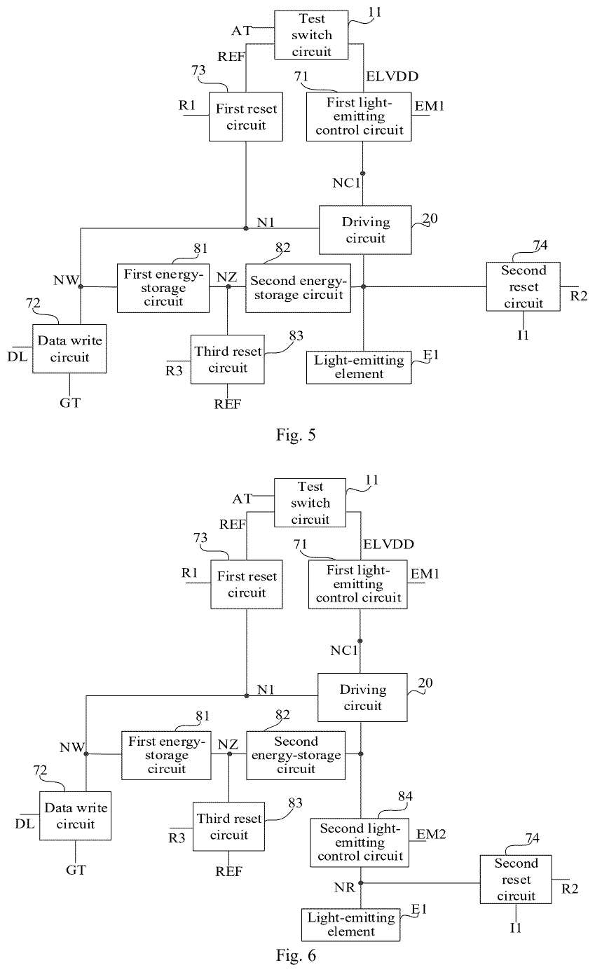

As shown in FIG. 5, based on the at least one embodiment of the pixel circuit shown in FIG. 1, the first test terminal is electrically connected to a reference voltage line REF, and the second test terminal is electrically connected to a power voltage line ELVDD;
the pixel driving circuit includes the driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;
the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EM1, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other; and the write node NW is electrically connected to the first node N1;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and the second terminal of the driving circuit 20, and is used for, under control of a second reset control signal provided by the second reset control line R2, controlling the initial voltage line Il and the second terminal of the driving circuit 20 to be connected or disconnected from each other;
the pixel circuit in at least one embodiment of the present disclosure further includes a first energy-storage circuit 81, a second energy-storage circuit 82, and a third reset circuit 83;
the first energy-storage circuit 81 is electrically connected to the write node NW and an intermediate node NZ, and is used for storing electric energy;
the second energy-storage circuit 82 is electrically connected to the intermediate node NZ and the second terminal of the driving circuit 20, and is used for storing electric energy; and
the third reset circuit 83 is electrically connected to a third reset control line R3, the reference voltage line REF, and the intermediate node NZ, and is used for, under control of a third reset control signal provided by the third reset control line R3, controlling the reference voltage line REF and the intermediate node NZ to be connected or disconnected from each other.

The pixel circuit in at least one embodiment of the present disclosure further includes a second light-emitting control circuit;
the reset node is electrically connected to the second terminal of the driving circuit through the second light-emitting control circuit; the reset node is electrically connected to a first electrode of the light-emitting element, and a second electrode of the light-emitting element is electrically connected to a low voltage line; and
a control terminal of the second light-emitting control circuit is electrically connected to a second light-emitting control line, and the second light-emitting control circuit is used for, under control of a second light-emitting control signal provided by the second light-emitting control line, controlling the reset node and the second terminal of the driving circuit to be connected or disconnected from each other.

As shown in FIG. 6, based on the at least one embodiment of the pixel circuit shown in FIG. 1, the first test terminal is electrically connected to a reference voltage line REF, and the second test terminal is electrically connected to a power voltage line ELVDD;
the pixel driving circuit includes the driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;
the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EM1, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other; and the write node NW is electrically connected to the first node N1;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and a reset node NR, and is used for, under control of a second reset control signal provided by the second reset control line R2, controlling the initial voltage line I1 and the reset node NR to be connected or disconnected from each other;
the pixel circuit in at least one embodiment of the present disclosure further includes a first energy-storage circuit 81, a second energy-storage circuit 82, and a third reset circuit 83;
the first energy-storage circuit 81 is electrically connected to the write node NW and an intermediate node NZ, and is used for storing electric energy;
the second energy-storage circuit 82 is electrically connected to the intermediate node NZ and the second terminal of the driving circuit 20, and is used for storing electric energy;
the third reset circuit 83 is electrically connected to a third reset control line R3, the reference voltage line REF, and the intermediate node NZ, and is used for, under control of a third reset control signal provided by the third reset control line R3, controlling the reference voltage line REF and the intermediate node NZ to be connected or disconnected from each other;
the pixel circuit further includes a second light-emitting control circuit 84;
the reset node NR is electrically connected to the second terminal of the driving circuit 20 through the second light-emitting control circuit 84; the reset node NR is electrically connected to a first electrode of the light-emitting element E1, and a second electrode of the light-emitting element E1 is electrically connected to a low voltage line ELVSS; and
a control terminal of the second light-emitting control circuit 84 is electrically connected to a second light-emitting control line EM2, and the second light-emitting control circuit 84 is used for, under control of a second light-emitting control signal provided by the second light-emitting control line EM2, controlling the reset node NR and the second terminal of the driving circuit 20 to be connected or disconnected from each other.

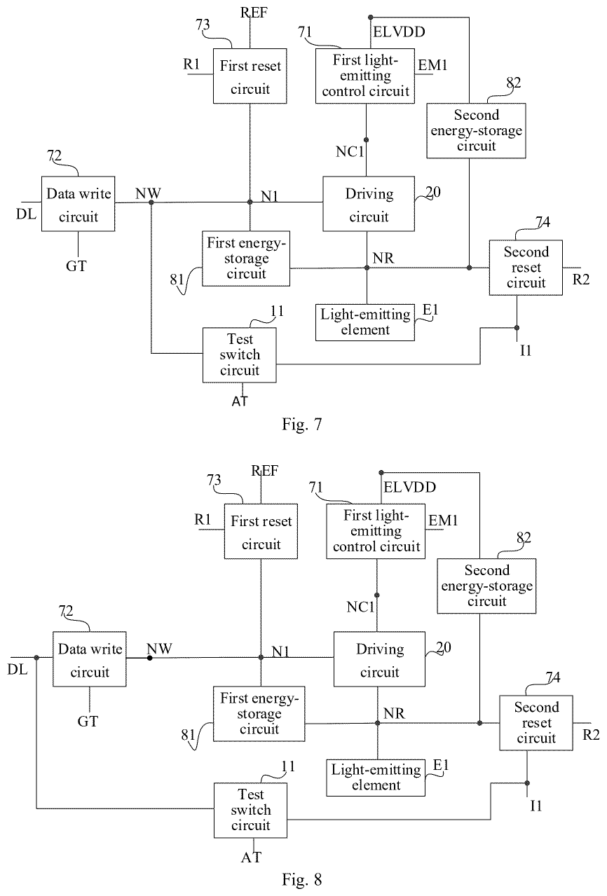

As shown in FIG. 7, based on the at least one embodiment of the pixel circuit shown in FIG. 1, the first test terminal is electrically connected to an initial voltage line I1, and the second test terminal is electrically connected to a second test node; the second test node is electrically connected to the first node N1;
the pixel driving circuit includes the driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;
the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EM1, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other; and the write node NW is electrically connected to the first node N1;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and a reset node NR, and is used for, under control of a second reset control signal provided by the second reset control line R2, controlling the initial voltage line I1 and the reset node NR to be connected or disconnected from each other; and the reset node NR is electrically connected to the second terminal of the driving circuit 20;
the pixel circuit in at least one embodiment of the present disclosure further includes a first energy-storage circuit 81 and a second energy-storage circuit 82;
the first energy-storage circuit 81 is electrically connected to the first node N1 and the second terminal of the driving circuit 20, and is used for storing electric energy; and
the second energy-storage circuit 82 is electrically connected to the power voltage line ELVDD and the second terminal of the driving circuit 20, and is used for storing electric energy.

As shown in FIG. 8, based on the at least one embodiment of the pixel circuit shown in FIG. 1, the first test terminal is electrically connected to an initial voltage line I1, and the second test terminal is electrically connected to the data line DL;
the pixel driving circuit includes the driving circuit 20 and a driving control circuit;
a control terminal of the driving circuit 20 is electrically connected to a first node N1; a first terminal of the driving circuit 20 is electrically connected to a first test node NC1, a second terminal of the driving circuit 20 is electrically connected to the light-emitting element E1, and the driving circuit 20 is used for, under control of a potential of the first node N1, generating a drive current for driving the light-emitting element E1;
the driving control circuit includes a first light-emitting control circuit 71, a data write circuit 72, a first reset circuit 73, and a second reset circuit 74;
the first light-emitting control circuit 71 is electrically connected to a first light-emitting control line EM1, the power voltage line ELVDD, and the first terminal of the driving circuit 20, and is used for, under control of a first light-emitting control signal provided by the first light-emitting control line EM1, controlling the power voltage line ELVDD and the first terminal of the driving circuit 20 to be connected or disconnected from each other;
the data write circuit 72 is electrically connected to a scan line GT, a data line DL, and a write node NW, and is used for, under control of a scan signal provided by the scan line GT, controlling the data line DL and the write node NW to be connected or disconnected from each other; and the write node NW is electrically connected to the first node N1;
the first reset circuit 73 is electrically connected to a first reset control line R1, the reference voltage line REF, and the first node N1, and is used for, under control of a first reset control signal R1 provided by the first reset control line, controlling the reference voltage line REF and the first node N1 to be connected or disconnected from each other;
the second reset circuit 74 is electrically connected to a second reset control line R2, the initial voltage line I1, and a reset node NR, and is used for, under control of a second reset control signal provided by the second reset control line R2, controlling the initial voltage line I1 and the reset node NR to be connected or disconnected from each other; and the reset node NR is electrically connected to the second terminal of the driving circuit 20;
the pixel circuit in at least one embodiment of the present disclosure further includes a first energy-storage circuit 81 and a second energy-storage circuit 82;
the first energy-storage circuit 81 is electrically connected to the first node N1 and the second terminal of the driving circuit 20, and is used for storing electric energy; and
the second energy-storage circuit 82 is electrically connected to the power voltage line ELVDD and the second terminal of the driving circuit 20, and is used for storing electric energy.

Optionally, the driving circuit includes a driving transistor, the first light-emitting control circuit includes a first transistor, the data write circuit includes a second transistor, the first reset circuit includes a third transistor, and the second reset circuit includes a fourth transistor;
a gate electrode of the driving transistor is electrically connected to the first node, a first electrode of the driving transistor is electrically connected to the first test node, and a second electrode of the driving transistor is electrically connected to the light-emitting element;
a gate electrode of the first transistor is electrically connected to the first light-emitting control line, a first electrode of the first transistor is electrically connected to the power voltage line, and a second electrode of the first transistor is electrically connected to the first electrode of the driving transistor;
a gate electrode of the second transistor is electrically connected to the scan line, a first electrode of the second transistor is electrically connected to the data line, and a second electrode of the second transistor is electrically connected to the write node;
a gate electrode of the third transistor is electrically connected to the first reset control line, a first electrode of the third transistor is electrically connected to the reference voltage line, and a second electrode of the third transistor is electrically connected to the first node; and
a gate electrode of the fourth transistor is electrically connected to the second reset control line, a first electrode of the fourth transistor is electrically connected to the initial voltage line, and a second electrode of the fourth transistor is electrically connected to the reset node.

Optionally, the first energy-storage circuit includes a first capacitor, and the second energy-storage circuit includes a second capacitor;
a first terminal of the first capacitor is electrically connected to the first node, and a second terminal of the first capacitor is electrically connected to the second terminal of the driving circuit; and
a first terminal of the second capacitor is electrically connected to the power voltage line, and a second terminal of the second capacitor is electrically connected to the second terminal of the driving circuit.

Optionally, the first energy-storage circuit includes a first capacitor, and the second energy-storage circuit includes a second capacitor; the third reset circuit includes a fifth transistor;
a first terminal of the first capacitor is electrically connected to the write node, and a second terminal of the first capacitor is electrically connected to the intermediate node;
a first terminal of the second capacitor is electrically connected to the intermediate node, and a second terminal of the second capacitor is electrically connected to the second terminal of the driving circuit; and
a gate electrode of the fifth transistor is electrically connected to the third reset control line, a first electrode of the fifth transistor is electrically connected to the reference voltage line, and a second electrode of the fifth transistor is electrically connected to the intermediate node.

Optionally, the switch control circuit includes a sixth transistor; and
a gate electrode of the sixth transistor is electrically connected to the switch control line, a first electrode of the sixth transistor is electrically connected to the first node, and a second electrode of the sixth transistor is electrically connected to the write node.

Optionally, the second light-emitting control circuit includes a seventh transistor; and
a gate electrode of the seventh transistor is electrically connected to the second light-emitting control line, a first electrode of the seventh transistor is electrically connected to the second terminal of the driving circuit, and a second electrode of the seventh transistor is electrically connected to the reset node.

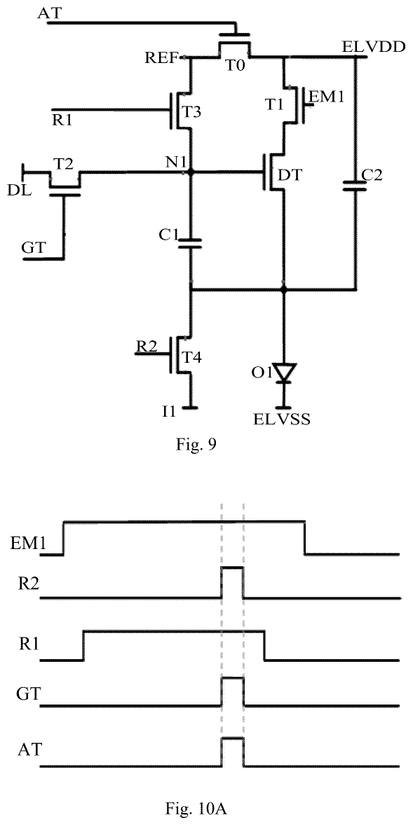

As shown in FIG. 9, based on the at least one embodiment of the pixel circuit shown in FIG. 2, the light-emitting element is an organic light-emitting diode O1; the test switch circuit includes a test switch transistor T0;
a gate electrode of the test switch transistor T0 is electrically connected to the test control terminal AT, a drain electrode of the test switch transistor T0 is electrically connected to the reference voltage line REF, and a source electrode of the test switch transistor T0 is electrically connected to the power voltage line ELVDD;
the driving circuit includes a driving transistor DT, the first light-emitting control circuit includes a first transistor T1, the data write circuit includes a second transistor T2, the first reset circuit includes a third transistor T3, and the second reset circuit includes a fourth transistor T4;
a gate electrode of the driving transistor DT is electrically connected to the first node N1, and a source electrode of the driving transistor DT is electrically connected to an anode of O1;
a gate electrode of the first transistor T1 is electrically connected to a first light-emitting control line EM1, a drain electrode of the first transistor T1 is electrically connected to the power voltage line ELVDD, and a source electrode of the first transistor T1 is electrically connected to the drain electrode of the driving transistor DT;
a gate electrode of the second transistor T2 is electrically connected to the scan line GT, a drain electrode of the second transistor T2 is electrically connected to the data line DL, and a source electrode of the second transistor T2 is electrically connected to the first node N1;
a gate electrode of the third transistor T3 is electrically connected to the first reset control line R1, a drain electrode of the third transistor T3 is electrically connected to the reference voltage line REF, and a source electrode of the third transistor T3 is electrically connected to the first node N1;
a gate electrode of the fourth transistor T4 is electrically connected to the second reset control line R2, a drain electrode of the fourth transistor T4 is electrically connected to the initial voltage line I1, and a source electrode of the fourth transistor T4 is electrically connected to the anode of O1;
the first energy-storage circuit includes a first capacitor C1, and the second energy-storage circuit includes a second capacitor C2;
a first terminal of the first capacitor C1 is electrically connected to the first node N1, and a second terminal of the first capacitor C1 is electrically connected to the anode of O1;
a first terminal of the second capacitor C2 is electrically connected to the power voltage line ELVDD, and a second terminal of the second capacitor C2 is electrically connected to the anode of O1; and a cathode of O1 is electrically connected to the low voltage line ELVSS.

In at least one embodiment of the pixel circuit shown in FIG. 9, all transistors are n-type transistors, but are not limited thereto.

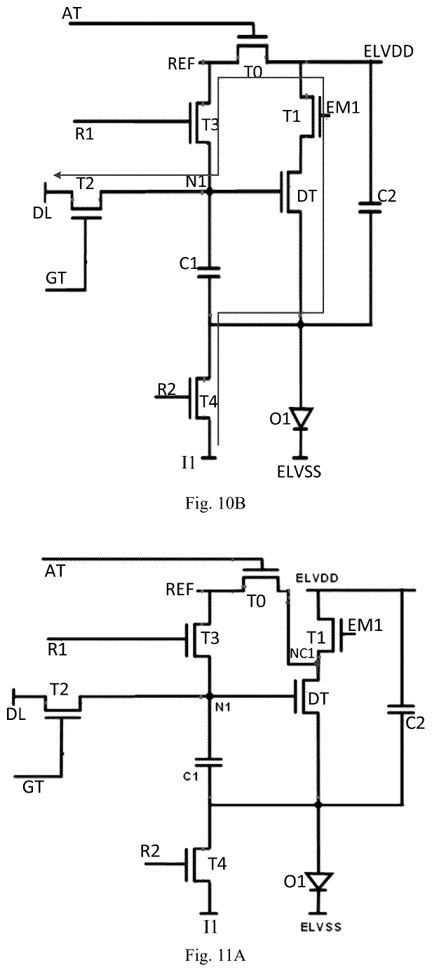

FIG. 10A is an operating timing diagram of at least one embodiment of the pixel circuit shown in FIG. 9.

As shown in FIG. 10A, during operation of the at least one embodiment of the pixel circuit shown in FIG. 9 of the present disclosure, in a detection phase S0, EM1 provides a high-voltage signal, R2 provides a high-voltage signal, R1 provides a high-voltage signal, GT provides a high-voltage signal, and AT provides a high-voltage signal. As shown in FIG. 10B, T1 is turned on, T0 is turned on, T3 is turned on, T2 is turned on, T4 is turned on, and DT is turned on, to form a current path passing through I1, T4, DT, T1, T0, T3, T2, to reach DL. The performance of the transistors on the current path can be detected by detecting a current on the current path.

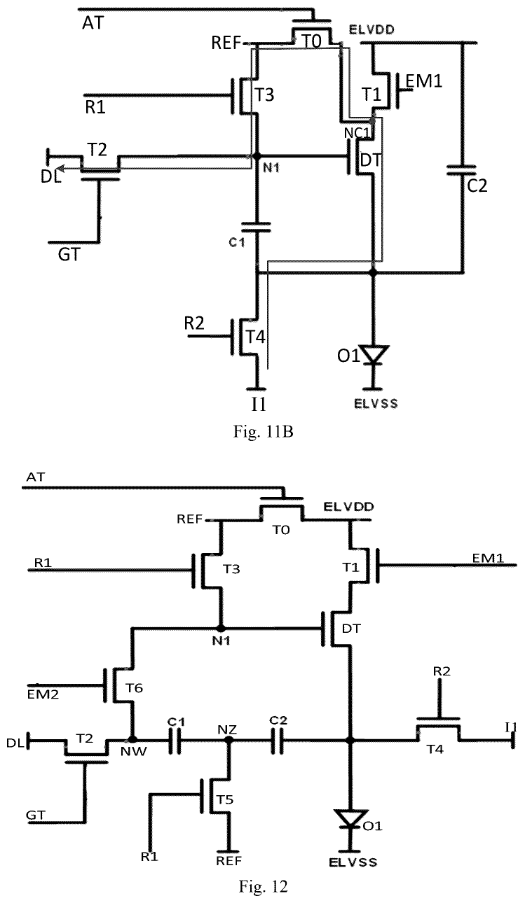

A difference between at least one embodiment of the pixel circuit shown in FIG. 11 and the at least one embodiment of the pixel circuit shown in FIG. 9 lies in that the source electrode of the T0 is electrically connected to the first test node NC1.

As shown in FIG. 10A, during operation of the at least one embodiment of the pixel circuit shown in FIG. 11A of the present disclosure, in a detection phase S0, EM1 provides a high-voltage signal, R2 provides a high-voltage signal, R1 provides a high-voltage signal, GT provides a high-voltage signal, and AT provides a high-voltage signal. As shown in FIG. 11B, T1 is turned on, T0 is turned on, T3 is turned on, T2 is turned on, T4 is turned on, and DT is turned on, to form a current path that passes through I1, T4, DT, T1, T0, T3, and T2 to reach DL. The performance of the transistors on the current path can be detected by detecting a current on the current path.

As shown in FIG. 12, based on the at least one embodiment of the pixel circuit shown in FIG. 4, the light-emitting element is an organic light-emitting diode O1; the test switch circuit includes a test switch transistor T0;
a gate electrode of the test switch transistor T0 is electrically connected to the test control terminal AT, a drain electrode of the test switch transistor T0 is electrically connected to the reference voltage line REF, and a source electrode of the test switch transistor T0 is electrically connected to the power voltage line ELVDD;
the driving circuit includes a driving transistor DT, the first light-emitting control circuit includes a first transistor T1, the data write circuit includes a second transistor T2, the first reset circuit includes a third transistor T3, and the second reset circuit includes a fourth transistor T4;
a gate electrode of the driving transistor DT is electrically connected to the first node N1, and a source electrode of the driving transistor DT is electrically connected to an anode of O1;
a gate electrode of the first transistor T1 is electrically connected to a first light-emitting control line EM1, a drain electrode of the first transistor T1 is electrically connected to the power voltage line ELVDD, and a source electrode of the first transistor T1 is electrically connected to the drain electrode of the driving transistor DT;
a gate electrode of the second transistor T2 is electrically connected to the scan line GT, a drain electrode of the second transistor T2 is electrically connected to the data line DL, and a source electrode of the second transistor T2 is electrically connected to the write node NW;
a gate electrode of the third transistor T3 is electrically connected to the first reset control line R1, a drain electrode of the third transistor T3 is electrically connected to the reference voltage line REF, and a source electrode of the third transistor T3 is electrically connected to the first node N1;
a gate electrode of the fourth transistor T4 is electrically connected to the second reset control line R2, a drain electrode of the fourth transistor T4 is electrically connected to the initial voltage line I1, and a source electrode of the fourth transistor T4 is electrically connected to the anode of O1;
the first energy-storage circuit includes a first capacitor C1, and the second energy-storage circuit includes a second capacitor C2; the third reset circuit includes a fifth transistor T5;
a first terminal of the first capacitor C1 is electrically connected to the write node NW, and a second terminal of the first capacitor C1 is electrically connected to the intermediate node NZ;
a first terminal of the second capacitor C2 is electrically connected to the intermediate node NZ, and a second terminal of the second capacitor C2 is electrically connected to the anode of O1;
a gate electrode of the fifth transistor T5 is electrically connected to the first reset control line R1, a drain electrode of the fifth transistor T5 is electrically connected to the reference voltage line REF, and a source electrode of the fifth transistor T5 is electrically connected to the intermediate node NZ;
the switch control circuit includes a sixth transistor T6; and a gate electrode of the sixth transistor T6 is electrically connected to the second light-emitting control line EM2, a drain electrode of the sixth transistor T6 is electrically connected to the first node N1, and a source electrode of the sixth transistor T6 is electrically connected to the write node NW.

In at least one embodiment of the pixel circuit shown in FIG. 12, all transistors are n-type transistors, but are not limited thereto.

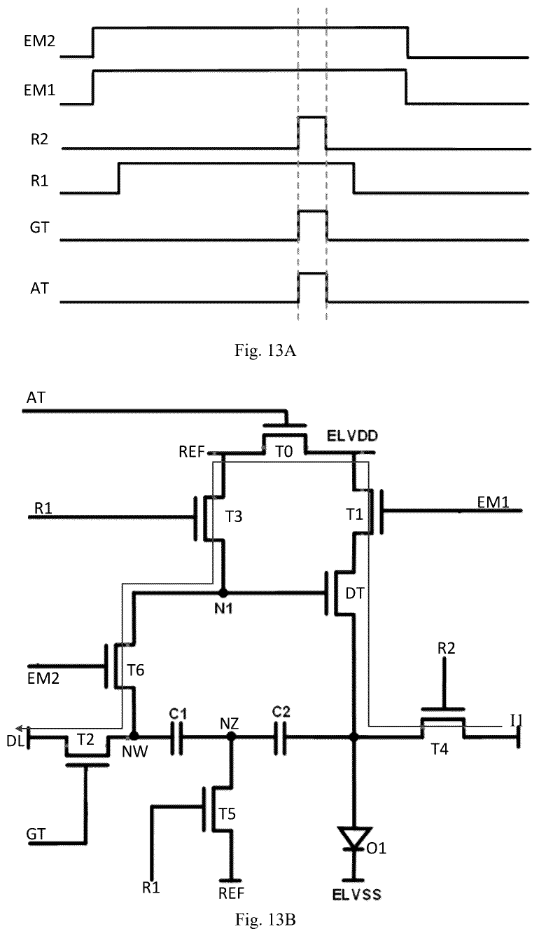

FIG. 13A is an operating timing diagram of at least one embodiment of the pixel circuit shown in FIG. 12.

As shown in FIG. 13A, during operation of the at least one embodiment of the pixel circuit shown in FIG. 12 of the present disclosure, in the detection phase S0, EM2, EM1, R2, R1, GT, and AT all provide high-voltage signals, and T0, T1, T2, T3, T4, T5, T6, and DT are turned on. As shown in FIG. 13B, a current path that passes through I1, T4, DT, T1, T0, T3, T6, and T2 to reach DL is formed. The performance of the transistors on the current path can be detected by detecting a current on the current path.

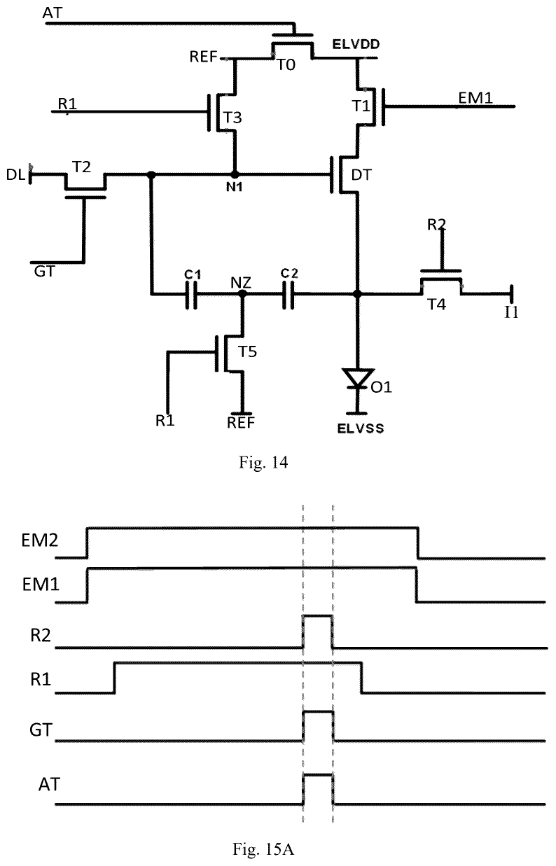

As shown in FIG. 14, based on the at least one embodiment of the pixel circuit shown in FIG. 5, the light-emitting element is an organic light-emitting diode O1; the test switch circuit includes a test switch transistor T0;
a gate electrode of the test switch transistor T0 is electrically connected to the test control terminal AT, a drain electrode of the test switch transistor T0 is electrically connected to the reference voltage line REF, and a source electrode of the test switch transistor T0 is electrically connected to the power voltage line ELVDD;
the driving circuit includes a driving transistor DT, the first light-emitting control circuit includes a first transistor T1, the data write circuit includes a second transistor T2, the first reset circuit includes a third transistor T3, and the second reset circuit includes a fourth transistor T4;
a gate electrode of the driving transistor DT is electrically connected to the first node N1, and a source electrode of the driving transistor DT is electrically connected to an anode of O1;
a gate electrode of the first transistor T1 is electrically connected to a first light-emitting control line EM1, a drain electrode of the first transistor T1 is electrically connected to the power voltage line ELVDD, and a source electrode of the first transistor T1 is electrically connected to the drain electrode of the driving transistor DT;
a gate electrode of the second transistor T2 is electrically connected to the scan line GT, a drain electrode of the second transistor T2 is electrically connected to the data line DL, and a source electrode of the second transistor T2 is electrically connected to the first node N1;
a gate electrode of the third transistor T3 is electrically connected to the first reset control line R1, a drain electrode of the third transistor T3 is electrically connected to the reference voltage line REF, and a source electrode of the third transistor T3 is electrically connected to the first node N1;
a gate electrode of the fourth transistor T4 is electrically connected to the second reset control line R2, a drain electrode of the fourth transistor T4 is electrically connected to the initial voltage line I1, and a source electrode of the fourth transistor T4 is electrically connected to the anode of O1;
the first energy-storage circuit includes a first capacitor C1, and the second energy-storage circuit includes a second capacitor C2; the third reset circuit includes a fifth transistor T5;
a first terminal of the first capacitor C1 is electrically connected to the first node N1, and a second terminal of the first capacitor C1 is electrically connected to the intermediate node NZ;
a first terminal of the second capacitor C2 is electrically connected to the intermediate node NZ, and a second terminal of the second capacitor C2 is electrically connected to the anode of O1; and
a gate electrode of the fifth transistor T5 is electrically connected to the first reset control line R1, a drain electrode of the fifth transistor T5 is electrically connected to the reference voltage line REF, and a source electrode of the fifth transistor T5 is electrically connected to the intermediate node NZ.

In at least one embodiment of the pixel circuit shown in FIG. 14, all transistors are n-type transistors, but are not limited thereto.

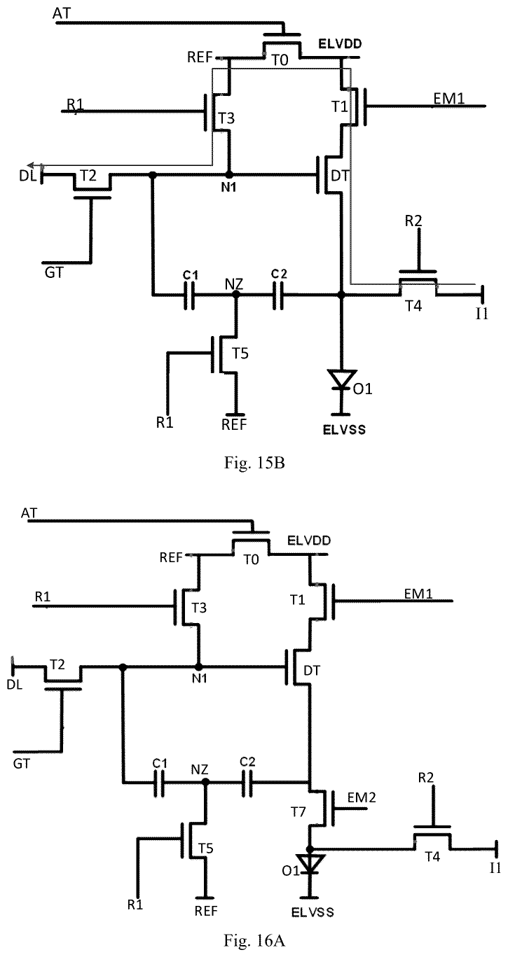

FIG. 15A is an operating timing diagram of at least one embodiment of the pixel circuit shown in FIG. 14.

As shown in FIG. 15A, during operation of the at least one embodiment of the pixel circuit shown in FIG. 14 of the present disclosure, in the detection phase S0, EM2, EM1, R2, R1, GT, and AT all provide high-voltage signals, and T0, T1, T2, T3, T4, T5, and DT are all turned on. As shown in FIG. 15B, a current path that passes through I1, T4, DT, T1, T0, T3, and T2 to reach DL is formed. The performance of the transistors on the current path can be detected by detecting a current on the current path.

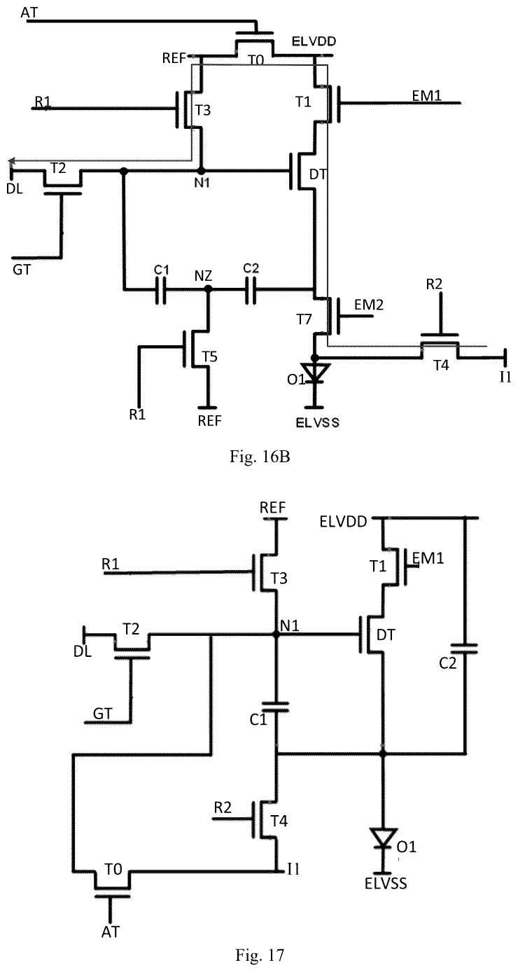

As shown in FIG. 16A, based on the at least one embodiment of the pixel circuit shown in FIG. 6, the light-emitting element is an organic light-emitting diode O1; the test switch circuit includes a test switch transistor T0;
a gate electrode of the test switch transistor T0 is electrically connected to the test control terminal AT, a drain electrode of the test switch transistor T0 is electrically connected to the reference voltage line REF, and a source electrode of the test switch transistor T0 is electrically connected to the power voltage line ELVDD;
the driving circuit includes a driving transistor DT, the first light-emitting control circuit includes a first transistor T1, the data write circuit includes a second transistor T2, the first reset circuit includes a third transistor T3, and the second reset circuit includes a fourth transistor T4;
a gate electrode of the driving transistor DT is electrically connected to the first node N1, and a source electrode of the driving transistor DT is electrically connected to an anode of O1;
a gate electrode of the first transistor T1 is electrically connected to a first light-emitting control line EM1, a drain electrode of the first transistor T1 is electrically connected to the power voltage line ELVDD, and a source electrode of the first transistor T1 is electrically connected to the drain electrode of the driving transistor DT;
a gate electrode of the second transistor T2 is electrically connected to the scan line GT, a drain electrode of the second transistor T2 is electrically connected to the data line DL, and a source electrode of the second transistor T2 is electrically connected to the first node N1;
a gate electrode of the third transistor T3 is electrically connected to the first reset control line R1, a drain electrode of the third transistor T3 is electrically connected to the reference voltage line REF, and a source electrode of the third transistor T3 is electrically connected to the first node N1;
a gate electrode of the fourth transistor T4 is electrically connected to the second reset control line R2, a drain electrode of the fourth transistor T4 is electrically connected to the initial voltage line I1, and a source electrode of the fourth transistor T4 is electrically connected to the anode of O1;
the first energy-storage circuit includes a first capacitor C1, and the second energy-storage circuit includes a second capacitor C2; the third reset circuit includes a fifth transistor T5;
a first terminal of the first capacitor C1 is electrically connected to the first node N1, and a second terminal of the first capacitor C1 is electrically connected to the intermediate node NZ;
a first terminal of the second capacitor C2 is electrically connected to the intermediate node NZ, and a second terminal of the second capacitor C2 is electrically connected to the source electrode of DT;
a gate electrode of the fifth transistor T5 is electrically connected to the first reset control line R1, a drain electrode of the fifth transistor T5 is electrically connected to the reference voltage line REF, and a source electrode of the fifth transistor T5 is electrically connected to the intermediate node NZ;
the second light-emitting control circuit includes a seventh transistor T7; and
a gate electrode of the seventh transistor T7 is electrically connected to the second light-emitting control line EM2, a drain electrode of the seventh transistor T7 is electrically connected to the source electrode of the driving transistor DT, and a source electrode of the seventh transistor T7 is electrically connected to the anode of O1.

In at least one embodiment of the pixel circuit shown in FIG. 16A, all transistors are n-type transistors, but are not limited thereto.

During operation of the at least one embodiment of the pixel circuit shown in FIG. 16A of the present disclosure, in the detection phase, EM1, EM2, R1, R2, GT, and AT all provide high-voltage signals, and DT, T0, T1, T2, T3, T4, and T5 are all turned on. As shown in FIG. 16B, a current path that passes through I1, T4, T7, DT, T1, T0, T3, and T2 to reach DL is formed. The performance of the transistors on the current path can be detected by detecting a current on the current path.

As shown in FIG. 17, based on the at least one embodiment of the pixel circuit shown in FIG. 7, the light-emitting element is an organic light-emitting diode O1; the test switch circuit includes a test switch transistor T0;
a gate electrode of the test switch transistor T0 is electrically connected to the test control terminal AT, a drain electrode of the test switch transistor T0 is electrically connected to the first node N1, and a source electrode of the test switch transistor T0 is electrically connected to the initial voltage line I1;
the driving circuit includes a driving transistor DT, the first light-emitting control circuit includes a first transistor T1, the data write circuit includes a second transistor T2, the first reset circuit includes a third transistor T3, and the second reset circuit includes a fourth transistor T4;
a gate electrode of the driving transistor DT is electrically connected to the first node N1, and a source electrode of the driving transistor DT is electrically connected to an anode of O1;
a gate electrode of the first transistor T1 is electrically connected to a first light-emitting control line EM1, a drain electrode of the first transistor T1 is electrically connected to the power voltage line ELVDD, and a source electrode of the first transistor T1 is electrically connected to the drain electrode of the driving transistor DT;
a gate electrode of the second transistor T2 is electrically connected to the scan line GT, a drain electrode of the second transistor T2 is electrically connected to the data line DL, and a source electrode of the second transistor T2 is electrically connected to the first node N1;
a gate electrode of the third transistor T3 is electrically connected to the first reset control line R1, a drain electrode of the third transistor T3 is electrically connected to the reference voltage line REF, and a source electrode of the third transistor T3 is electrically connected to the first node N1;
a gate electrode of the fourth transistor T4 is electrically connected to the second reset control line R2, a drain electrode of the fourth transistor T4 is electrically connected to the initial voltage line I1, and a source electrode of the fourth transistor T4 is electrically connected to the anode of O1;
the first energy-storage circuit includes a first capacitor C1, and the second energy-storage circuit includes a second capacitor C2;
a first terminal of the first capacitor C1 is electrically connected to the first node N1, and a second terminal of the first capacitor C1 is electrically connected to the anode of O1; and
a first terminal of the second capacitor C2 is electrically connected to the power voltage line ELVDD, and a second terminal of the second capacitor C2 is electrically connected to the anode of O1.

In at least one embodiment of the pixel circuit shown in FIG. 17, all transistors are n-type transistors, but are not limited thereto.

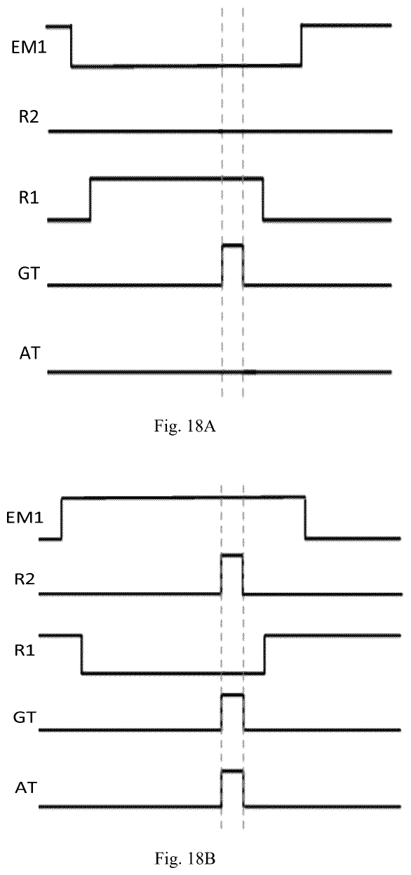

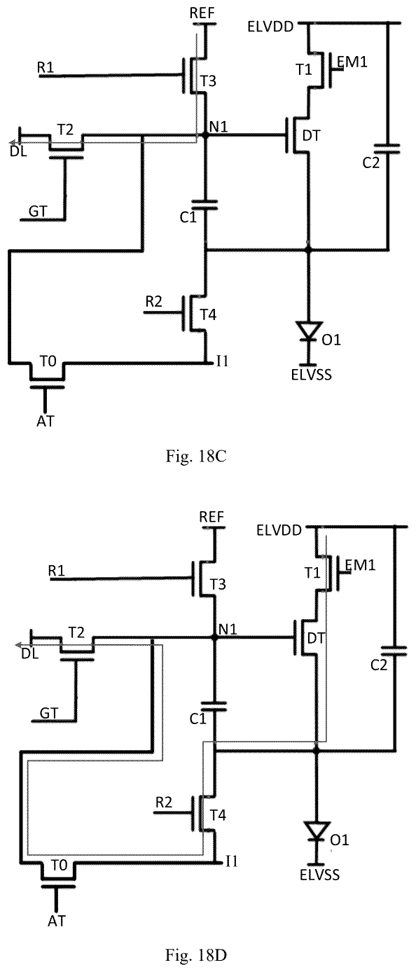

FIG. 18A is a first operating timing diagram of at least one embodiment of the pixel circuit shown in FIG. 17. FIG. 18B is a first operating timing diagram of at least one embodiment of the pixel circuit shown in FIG. 17.

As shown in FIG. 18A, during operation of the at least one embodiment of the pixel circuit shown in FIG. 17 of the present disclosure, in the detection phase S0, EM1, R2, and AT provide low-voltage signals, R1 and GT provide high-voltage signals, and T3 and T2 are both turned on. As shown in FIG. 18C, a first current path that passes through REF, T3, and T2 to reach DL is formed. The performance of the transistors on the first current path can be detected by detecting a current on the first current path.

As shown in FIG. 18B, during operation of the at least one embodiment of the pixel circuit shown in FIG. 17 of the present disclosure, in the detection phase S0, EM1, R2, GT, and AT all provide high-voltage signals, R1 provides a low-voltage signal, T1 is turned on, DT is turned on, T0 is turned on, T2 is turned on, and T4 is turned on. As shown in FIG. 18D, a second current path that passes through ELVDD, T1, DT, T4, T0, and T2 to reach DL is formed. The performance of the transistors on the second current path can be detected by detecting a current on the second current path.

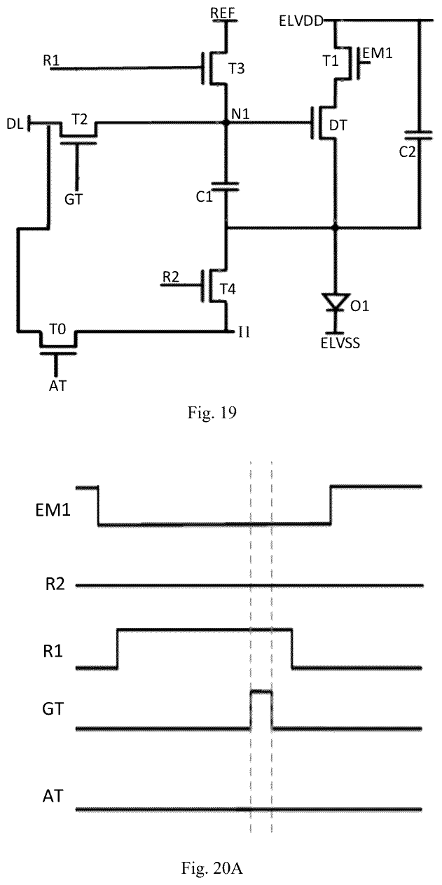

A difference between at least one embodiment of the pixel circuit shown in FIG. 19 and the at least one embodiment of the pixel circuit shown in FIG. 17 lies in that
the drain electrode of T0 is electrically connected to the data line DL.

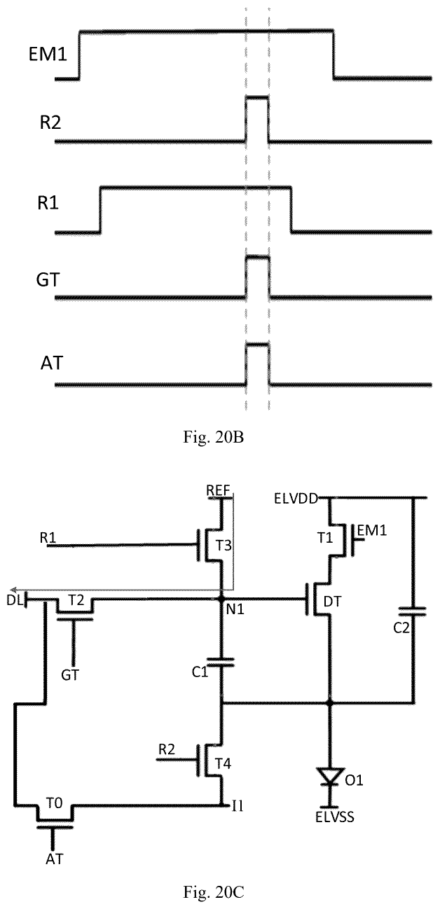

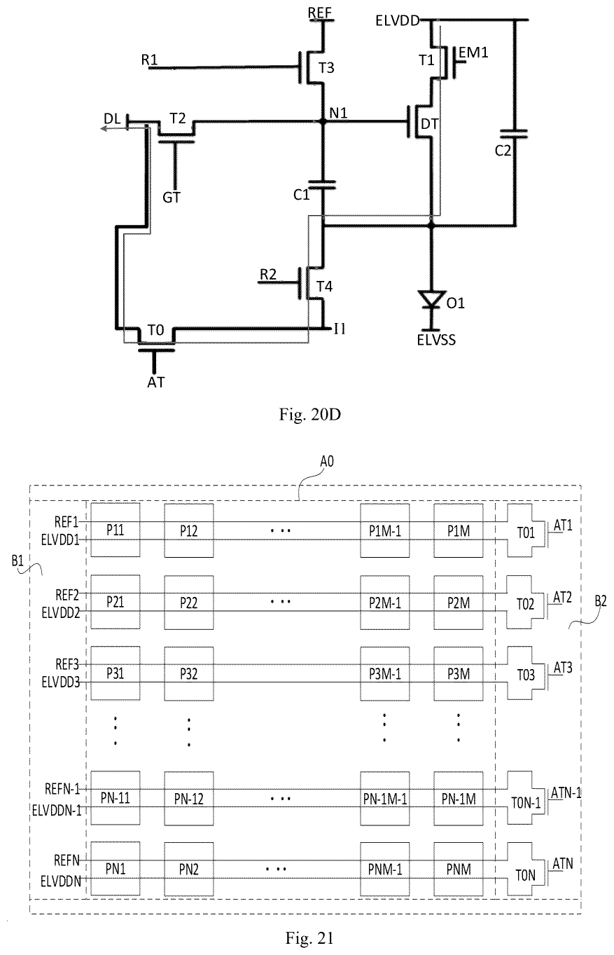

FIG. 20A is a first operating timing diagram of at least one embodiment of the pixel circuit shown in FIG. 19. FIG. 20B is a second operating timing diagram of at least one embodiment of the pixel circuit shown in FIG. 19.

As shown in FIG. 20A, during operation of the at least one embodiment of the pixel circuit shown in FIG. 19 of the present disclosure, in the detection phase S0, EM1, R2, and AT all provide low-voltage signals, R1 and GT provide high-voltage signals, and T3 and T2 are both turned on. As shown in FIG. 20C, a first current path that passes through REF, T3, and T2 to reach DL is formed. The performance of the transistors on the first current path can be detected by detecting a current on the first current path.

As shown in FIG. 20B, during operation of the at least one embodiment of the pixel circuit shown in FIG. 19 of the present disclosure, in the detection phase S0, EM1, R2, R1, GT, and AT all provide high-voltage signals, and T1, DT, T4, T0, T2, and T3 are all turned on. As shown in FIG. 20C, a second current path that passes through ELVSS, T1, DT, T4, and T0 to reach DL is formed. The performance of the transistors on the second current path can be detected by detecting a current on the second current path.

A pixel circuit test method according to embodiments of the present disclosure is applied to the foregoing pixel circuit. The method includes:

in a detection phase, providing a valid test control signal to the test control terminal, and controlling, by the test switch circuit under control of the test control signal, the first test terminal and the second test terminal to be connected to each other.

In the method according to the embodiments of the present disclosure, in a detection phase, the test switch circuit controls, under control of the test control signal, the first test terminal and the second test terminal to be connected to each other to form a current path, and the performance of transistors on the current path can be detected by detecting a current on the current path.

In at least one embodiment of the present disclosure, the method further includes:
in a display phase, providing an invalid test control signal to the test control terminal, controlling, by the test switch circuit under control of the test control signal, the first test terminal and the second test terminal to be disconnected from each other, and generating, by the pixel driving circuit, the drive current for driving the light-emitting element.

Optionally, the pixel driving circuit includes the driving circuit and a driving control circuit; and the method includes:
in the detection phase, controlling, by the driving control circuit, the control terminal of the driving circuit and the first terminal of the driving circuit to be connected to each other.

During specific implementation, the pixel driving circuit may include a driving circuit and a driving control circuit. The driving control circuit controls the control terminal of the driving circuit and the first terminal of the driving circuit to be connected to each other in response to the test switch circuit controlling the first test terminal and the second test terminal to be connected to each other. A current flowing through the driving circuit is detected, and the performance of a driving transistor included in the driving circuit may be detected according to a detection result to perform an AT on the pixel circuit.

A display apparatus according to embodiments of the present disclosure includes the foregoing pixel circuit.

A display panel according to embodiments of the present disclosure includes pixel circuits in a plurality of rows and a plurality of columns, a plurality of first direct current voltage lines, and a plurality of second direct current voltage lines, where the pixel circuits are disposed in a display area; the display panel further includes a test switch module disposed in a bezel area; the test switch module includes a plurality of test switch circuits; and
each of the test switch circuits is electrically connected to a test control terminal, one of the first direct current voltage lines, and one of the second direct current voltage lines, and is used for, under control of a test control signal provided by the test control terminal, controlling the first direct current voltage line and the second direct current voltage line to be connected or disconnected from each other.

Optionally, the first direct current voltage lines may be reference voltage lines, and the second direct current voltage lines may be power voltage lines. During specific implementation, a test switch circuit may be disposed between the reference voltage line and a direct current voltage line. The first direct current voltage lines and the second direct current voltage lines may be disposed in a first direction. The first direction may be, for example, a horizontal direction. The bezel area may include a first bezel area and a second bezel area. The first bezel area may be disposed on a left side of the display area, and the second bezel area may be disposed on a right side of the display area. The test switch circuit may be disposed in the first bezel area and/or the second bezel area, and does not need to occupy a space of the display area, which helps to ensure a pixel density (PPI).

In at least one embodiment of the present disclosure, a test switch circuit may be not disposed on each of the pixel circuits, and it is only necessary to arrange one or two test switch circuits for each row of pixel circuits.

In at least one embodiment of the present disclosure, the first direct current voltage lines and the second direct current voltage lines all extend in a first direction; the display panel includes N rows of pixel circuits; the pixel circuits located in an n^{th} row are electrically connected to an n^{th} first direct current voltage line of the first direct current voltage lines and an n^{th} second direct current voltage line of the second direct current voltage lines; N is an integer greater than 1, and n is a positive integer less than or equal to N;
the test switch module includes N test switch circuits; and
an n^{th} test switch circuit of the test switch circuits is electrically connected to an n^{th} test control terminal, the n^{th} first direct current voltage line, and the n^{th} second direct current voltage line, and is used for, under control of an n^{th} test control signal provided by the n^{th} test control terminal, controlling the n^{th} first direct current voltage line and the n^{th} second direct current voltage line to be connected or disconnected from each other.

As shown in FIG. 21, a label A0 denotes the display area, a label B1 denotes the first bezel area, and a label B2 denotes the second bezel area;
a label P11 denotes the pixel circuit in the first row and the first column, a label P12 denotes the pixel circuit in the first row and the second column, a label PIM-1 denotes the pixel circuit in the first row and an (M−1)^{th} column, and a label PIM denotes the pixel circuit in the first row and an M^{th} column;
a label P21 denotes the pixel circuit in the second row and the first column, a label P22 denotes the pixel circuit in the second row and the second column, a label P2M-1 denotes the pixel circuit in the second row and the (M−1)^{th} column, and a label P2M denotes the pixel circuit in the second row and the M^{th} column;
a label P31 denotes the pixel circuit in the third row and the first column, a label P32 denotes the pixel circuit in the third row and the second column, a label P3M-1 denotes the pixel circuit in the third row and the (M−1)^{th} column, and a label P3M denotes the pixel circuit in the third row and the M^{th} column;
a label PN-11 denotes the pixel circuit in an (N-1)^{th} row and the first column, a label PN-12 denotes the pixel circuit in the (N-1)^{th} row and the second column, a label PN-1M-1 denotes the pixel circuit in the (N-1)^{th} row and the (M−1)^{th} column, and a label PN-1M denotes the pixel circuit in the (N-1)^{th} row and the M^{th} column;
a label PN1 denotes the pixel circuit in an N^{th} row and the first column, a label PN2 denotes the pixel circuit in the N^{th} row and the second column, a label PNM-1 denotes the pixel circuit in the N^{th} row and the (M−1)^{th} column, and a label PNM denotes the pixel circuit in the N^{th} row and the M^{th} column;
N and M are both integers greater than 1;
the pixel circuits located in the first row are electrically connected to the first reference voltage line REF1 and the first power voltage line ELVDD1;
the pixel circuits located in the second row are electrically connected to the second reference voltage line REF2 and the second power voltage line ELVDD2;
the pixel circuits located in the third row are electrically connected to the third reference voltage line REF3 and the third power voltage line ELVDD3;
the pixel circuits located in the (N-1)^{th} row are electrically connected to an (N-1)^{th} reference voltage line REFN-1 and an (N-1)^{th} power voltage line ELVDDN-1;
the pixel circuits located in the N^{th} row are electrically connected to an N^{th} reference voltage line REFN and an Nth power voltage line ELVDDN;
the test switch module includes N test switch circuits; the first test switch circuit includes the first test switch transistor T01, the second test switch circuit includes the second test switch transistor T02, the third test switch circuit includes the third test switch transistor T03, an (N-1)^{th} test switch circuit includes an (N-1)^{th} test switch transistor T0N-1, and the N^{th} test switch circuit includes an Nth test switch transistor T0N;
a gate electrode of T01 is electrically connected to the first test control terminal AT1, a drain electrode of T01 is electrically connected to REF1, and a source electrode of T01 is electrically connected to ELVDD1;
a gate electrode of T02 is electrically connected to the second test control terminal AT2, a drain electrode of T02 is electrically connected to REF2, and a source electrode of T02 is electrically connected to ELVDD2;
a gate electrode of T03 is electrically connected to the third test control terminal AT3, a drain electrode of T03 is electrically connected to REF3, and a source electrode of T03 is electrically connected to ELVDD3;
a gate electrode of T0N-1 is electrically connected to an (N-1)^{th} test control terminal ATN-1, a drain electrode of T0N-1 is electrically connected to REFN-1, and a source electrode of T0N-1 is electrically connected to ELVDDN-1;
a gate electrode of T0N is electrically connected to an N^{th} test control terminal ATN, a drain electrode of T0N is electrically connected to REFN, and a source electrode of T0N is electrically connected to ELVDDN; and
T01, T02, T03, T0N-1, and TON are all disposed in the second bezel area B2.

In at least one embodiment shown in FIG. 21, the test switch transistors may be alternatively disposed in the first bezel area, or the test switch transistors may be alternatively disposed in the first bezel area and the second bezel area.

The display panel in at least one embodiment of the present disclosure includes N rows of pixel circuits, where the pixel circuits located in an n^{th} row are electrically connected to an n^{th} first direct current voltage line of the first direct current voltage lines and an n^{th} second direct current voltage line of the second direct current voltage lines; N is an integer greater than 1, and n is a positive integer less than or equal to N; m is a positive integer less than N;
the test switch module includes at least one test switch circuit; and
an m^{th} test switch circuit of the test switch circuits is electrically connected to an m^{th} test control terminal, an m^{th} first direct current voltage line of the first direct current voltage lines, and an (m+1)^{th} second direct current voltage line of the second direct current voltage lines, and is used for, under control of an m^{th} test control signal provided by the m^{th} test control terminal, controlling the m^{th} first direct current voltage line and the (m+1)^{th} second direct current voltage line to be connected or disconnected from each other.

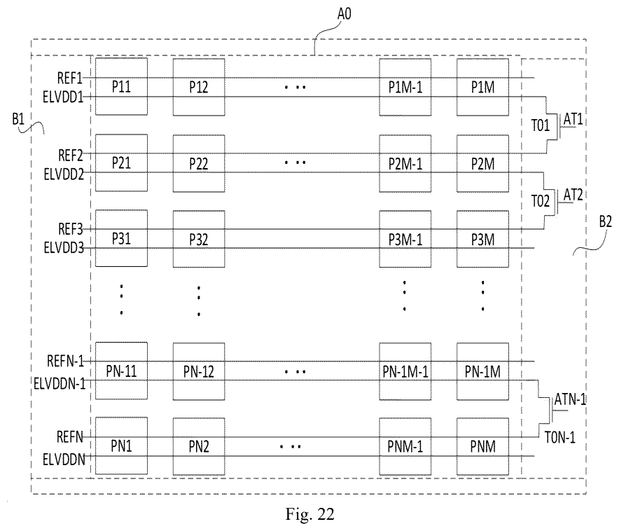

As shown in FIG. 22, a label A0 denotes the display area, a label B1 denotes the first bezel area, and a label B2 denotes the second bezel area;
a label P11 denotes the pixel circuit in the first row and the first column, a label P12 denotes the pixel circuit in the first row and the second column, a label PIM-1 denotes the pixel circuit in the first row and an (M−1)^{th} column, and a label PIM denotes the pixel circuit in the first row and an M^{th} column;
a label P21 denotes the pixel circuit in the second row and the first column, a label P22 denotes the pixel circuit in the second row and the second column, a label P2M-1 denotes the pixel circuit in the second row and the (M−1)^{th} column, and a label P2M denotes the pixel circuit in the second row and the M^{th} column;
a label P31 denotes the pixel circuit in the third row and the first column, a label P32 denotes the pixel circuit in the third row and the second column, a label P3M-1 denotes the pixel circuit in the third row and the (M−1)^{th} column, and a label P3M denotes the pixel circuit in the third row and the M^{th} column;
a label PN-11 denotes the pixel circuit in an (N-1)^{th} row and the first column, a label PN-12 denotes the pixel circuit in the (N-1)^{th} row and the second column, a label PN-1M-1 denotes the pixel circuit in the (N-1)^{th} row and the (M−1)^{th} column, and a label PN-1M denotes the pixel circuit in the (N-1)^{th} row and the M^{th} column;
a label PN1 denotes the pixel circuit in an N^{th} row and the first column, a label PN2 denotes the pixel circuit in the N^{th} row and the second column, a label PNM-1 denotes the pixel circuit in the N^{th} row and the (M−1)^{th} column, and a label PNM denotes the pixel circuit in the N^{th} row and the M^{th} column;
N and M are both integers greater than 1;
the pixel circuits located in the first row are electrically connected to the first reference voltage line REF1 and the first power voltage line ELVDD1;
the pixel circuits located in the second row are electrically connected to the second reference voltage line REF2 and the second power voltage line ELVDD2;
the pixel circuits located in the third row are electrically connected to the third reference voltage line REF3 and the third power voltage line ELVDD3;
the pixel circuits located in the (N−1)^{th} row are electrically connected to an (N−1)^{th} reference voltage line REFN-1 and an (N−1)^{th} power voltage line ELVDDN-1;
the pixel circuits located in the Nth row are electrically connected to an N^{th} reference voltage line REFN and an N^{th} power voltage line ELVDDN;
the test switch module includes at least one test switch circuit; the first test switch circuit includes the first test switch transistor T01, the second test switch circuit includes the second test switch transistor T02, and an (N−1)^{th} test switch circuit includes an (N−1)^{th} test switch transistor T0N-1;
a gate electrode of T01 is electrically connected to the first test control terminal AT1, a drain electrode of T01 is electrically connected to ELVDD1, and a source electrode of T01 is electrically connected to REF2;

a gate electrode of T02 is electrically connected to the second test control terminal AT2, a drain electrode of T02 is electrically connected to ELVDD2, and a source electrode of T02 is electrically connected to REF3;
a gate electrode of T0N-1 is electrically connected to an (N−1)^{th} test control terminal ATN-1, a drain electrode of T0N-1 is electrically connected to ELVDDN-1, and a source electrode of T0N-1 is electrically connected to REF; and T01, T02, and T0N-1 are all disposed in the second bezel area B2.

In at least one embodiment shown in FIG. 22, the test switch transistors may be alternatively disposed in the first bezel area, or the test switch transistors may be alternatively disposed in the first bezel area and the second bezel area.

In at least one embodiment of the present disclosure, the first direct current voltage lines include a plurality of rows of first direct current voltage line portions and a plurality of columns of second direct current voltage line portions that are electrically connected to each other, and the second direct current voltage lines include a plurality of rows of third direct current voltage line portions and a plurality of columns of fourth direct current voltage line portions that are electrically connected to each other;
an extension direction of the first direct current voltage line portions is the same as an extension direction of the third direct current voltage line portions, an extension direction of the second direct current voltage line portions is the same as an extension direction of the fourth direct current voltage line portions, and the extension direction of the first direct current voltage line portions intersects the extension direction of the second direct current voltage line portions;
the test switch module includes a plurality of first test switch circuits and a plurality of second test switch circuits;
each of the first test switch circuits is electrically connected to a corresponding test control terminal, one row of the first direct current voltage line portions, and one row of the third direct current voltage line portions, and is used for, under control of the test control signal provided by the test control terminal, controlling the row of the first direct current voltage line portions and the row of the third direct current voltage line portions to be connected or disconnected from each other; and
each of the second test switch circuits is electrically connected to a corresponding test control terminal, one column of the second direct current voltage line portions, and one column of the fourth direct current voltage line portions, and is used for, under control of the test control signal provided by the test control terminal, controlling the column of the second direct current voltage line portions and the column of the fourth direct current voltage line portions to be connected or disconnected from each other.

During specific implementation, the first direct current voltage lines may include a plurality of rows of first direct current voltage line portions and a plurality of columns of second direct current voltage line portions that are electrically connected to each other, and the second direct current voltage lines include a plurality of rows of third direct current voltage line portions and a plurality of columns of fourth direct current voltage line portions that are electrically connected to each other. The first direct current voltage line portions and the third direct current voltage line portions may extend in the horizontal direction, and the second direct current voltage line portions and the fourth direct current voltage line portions may extend in a vertical direction. The plurality of rows of first direct current voltage line portions and the plurality of columns of second direct current voltage line portions form a mesh structure, and the plurality of rows of third direct current voltage line portions and the plurality of columns of fourth direct current voltage line portions form a mesh structure. The bezel area may include a first bezel area, a second bezel area, a third bezel area, and a fourth bezel area. The first bezel area may be disposed on a left side of the display area, the second bezel area may be disposed on a right side of the display area, the third bezel area may be disposed on an upper side of the display area, and the fourth bezel area may be disposed on a lower side of the display area. The test switch circuits may be disposed in at least one of the first bezel area, the second bezel area, the third bezel area, and the fourth bezel area.

A display panel according to embodiments of the present disclosure includes pixel circuits in a plurality of rows and A columns, a plurality of third direct current voltage lines, and data lines in A columns, where A is an integer greater than 1; a is a positive integer less than or equal to A; the pixel circuits are disposed in a display area; the pixel circuits located in an a^{th} column are electrically connected to the data line in the a^{th} column;
the display panel further includes a test switch module disposed in a bezel area; the test switch module includes A test switch circuits; and
an a^{th} test switch circuit of the test switch circuits is electrically connected to an a^{th} test control terminal, one of the third direct current voltage lines, and the data line in the a^{th} column, and is used for, under control of an a^{th} test control signal provided by the a^{th} test control terminal, controlling the third direct current voltage line and the data line in the a^{th} column to be connected or disconnected from each other.

Optionally, the third direct current voltage lines may be initial voltage lines.

During specific implementation, the display panel may include a test switch module disposed in a bezel area. The test switch module may include a plurality of test switch circuits. The pixel circuits located in a same column may share one test switch circuit. The data lines extend in a vertical direction. The test switch circuit may be disposed in an upper bezel area or a lower bezel area, and does not occupy a space of the display area, which helps to ensure the pixel density (PPI).

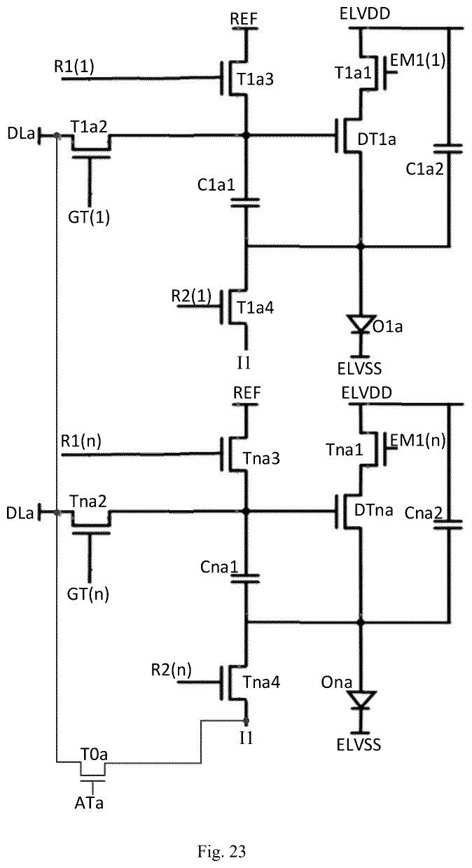

As shown in FIG. 23, the pixel circuit in the first row and the a^{th} column may include a first transistor T1a1 in the first row and the a^{th} column, a second transistor T1a2 in the first row and the a^{th} column, a third transistor T1a3 in the first row and the a^{th} column, a fourth transistor T1a4 in the first row and the a^{th} column, a first capacitor C1a1 in the first row and the a^{th} column, a second capacitor C1a2 in the first row and the a^{th} column, a driving transistor DT1a in the first row and the a^{th} column, and an organic light-emitting diode O1a in the first row and the a^{th} column;
the pixel circuit in the n^{th} row and the a^{th} column may include a first transistor Tna1 in the n^{th} row and the a^{th} column, a second transistor Tna2 in the n^{th} row and the a^{th} column, a third transistor Tna3 in the n^{t}h row and the a^{th} column, a fourth transistor Tna4 in the n^{th} row and the a^{th} column, a first capacitor Cna1 in the n^{th} row and the a^{th} column, a second capacitor Cna2 in the n^{th} row and the a^{th} column, a driving transistor DTna in the n^{th} row and the a^{th} column, and an organic light-emitting diode Ona in the n^{th} row and the a^{th} column;
a label R1(1) denotes the first reset control lines in the first row, a label R2(1) denotes the second reset control lines in the first row, a label EM1(1) denotes the first light-emitting control lines in the first row, and a label GT(1) denotes the scan lines in the first row;
a label R1(n) denotes the first reset control lines in the n^{th} row, a label R2(n) denotes the second reset control lines in the nth row, a label EM1(n) denotes the first light-emitting control lines in the n^{th} row, and a label GT(n) denotes the scan lines in the n^{th} row;
a label DLa denotes an a^{th} data line;
the display panel includes the a^{th} test switch circuit, and the a^{th} test switch circuit includes an a^{th} test switch transistor T0a; and
a gate electrode of T0a is electrically connected to an a^{th} test control terminal ATa, a drain electrode of T0a is electrically connected to DLa, and a source electrode of T0a is electrically connected to the initial voltage line I1.

A display apparatus according to embodiments of the present disclosure includes the foregoing display panel.

The foregoing descriptions are preferred implementation manners of the present disclosure. It should be noted that for a person of ordinary skill in the art, several improvements and modifications may further be made without departing from the principle of the present disclosure. These improvements and modifications should also be deemed as falling within the scope of the present disclosure.

1. A pixel circuit, comprising a pixel driving circuit, a light-emitting element, and a test switch circuit, wherein a control terminal of the test switch circuit is electrically connected to a test control terminal;
the test switch circuit is disposed between a first test terminal and a second test terminal, and is used for, under control of a test control signal provided by the test control terminal, controlling the first test terminal and the second test terminal to be connected or disconnected from each other;
the pixel driving circuit is electrically connected to the first test terminal, the second test terminal, and the light-emitting element, and is used for generating a drive current for driving the light-emitting element; and
the first test terminal is electrically connected to a first direct current voltage line, and the first test terminal is electrically connected to a second direct current voltage line or a test node; or the first test terminal is electrically connected to a direct current voltage line, and the second test terminal is electrically connected to a data line.

2. The pixel circuit according to claim 1, wherein the pixel driving circuit comprises a driving circuit and a driving control circuit;
a control terminal of the driving circuit is electrically connected to a first node; a first terminal of the driving circuit is electrically connected to a first test node, a second terminal of the driving circuit is electrically connected to the light-emitting element, and the driving circuit is used for generating a drive current under control of a potential of the first node; and
the driving control circuit is used for controlling the control terminal of the driving circuit and the first terminal of the driving circuit to be connected to each other in response to the test switch circuit controlling the first test terminal and the second test terminal to be connected to each other.

3. The pixel circuit according to claim 2, wherein the first test terminal is electrically connected to a reference voltage line, and the second test terminal is electrically connected to a power voltage line; or the first test terminal is electrically connected to an initial voltage line, and the second test terminal is electrically connected to the data line; or the first test terminal is electrically connected to a reference voltage line, and the second test terminal is electrically connected to the first test node; or the first test terminal is electrically connected to an initial voltage line, and the second test terminal is electrically connected to a second test node.

4. The pixel circuit according to claim 1, wherein the test switch circuit comprises a test switch transistor; and
a gate electrode of the test switch transistor is electrically connected to the test control terminal, a first electrode of the test switch transistor is electrically connected to the first test terminal, and a second electrode of the test switch transistor is electrically connected to the second test terminal.

5. The pixel circuit according to claim 3, wherein the driving control circuit comprises a first light-emitting control circuit, a data write circuit, a first reset circuit, and a second reset circuit;
the first light-emitting control circuit is electrically connected to a first light-emitting control line, the power voltage line, and the first terminal of the driving circuit, and is used for, under control of a first light-emitting control signal provided by the first light-emitting control line, controlling the power voltage line and the first terminal of the driving circuit to be connected or disconnected from each other;
the data write circuit is electrically connected to a scan line, the data line, and a write node, and is used for, under control of a scan signal provided by the scan line, controlling the data line and the write node to be connected or disconnected from each other; the second test node is electrically connected to the write node; the write node is electrically connected to the first node;
the first reset circuit is electrically connected to a first reset control line, the reference voltage line, and the first node, and is used for, under control of a first reset control signal provided by the first reset control line, controlling the reference voltage line and the first node to be connected or disconnected from each other;
the second reset circuit is electrically connected to a second reset control line, the initial voltage line, and a reset node, and is used for, under control of a second reset control signal provided by the second reset control line, controlling the initial voltage line and the reset node to be connected or disconnected from each other; and the reset node is electrically connected to the second terminal of the driving circuit.

6. The pixel circuit according to claim 5, further comprising a first energy-storage circuit and a second energy-storage circuit,
wherein the first energy-storage circuit is electrically connected to the first node and the second terminal of the driving circuit, and is used for storing electric energy; and
the second energy-storage circuit is electrically connected to the power voltage line and the second terminal of the driving circuit, and is used for storing electric energy.

7. The pixel circuit according to claim 5, further comprising a first energy-storage circuit, a second energy-storage circuit, and a third reset circuit,
wherein the first energy-storage circuit is electrically connected to the write node and an intermediate node, and is used for storing electric energy;
the second energy-storage circuit is electrically connected to the intermediate node and the second terminal of the driving circuit, and is used for storing electric energy; and
the third reset circuit is electrically connected to a third reset control line, the reference voltage line, and the intermediate node, and is used for, under control of a third reset control signal provided by the third reset control line, controlling the reference voltage line and the intermediate node to be connected or disconnected from each other.

8. The pixel circuit according to claim 7, further comprising a switch control circuit,
wherein the first node is electrically connected to the write node through the switch control circuit; and
a control terminal of the switch control circuit is electrically connected to a switch control line, and the switch control circuit is used for, under control of a switch control signal provided by the switch control line, controlling the first node and the write node to be connected or disconnected from each other; wherein the switch control circuit comprises a sixth transistor; and
a gate electrode of the sixth transistor is electrically connected to the switch control line, a first electrode of the sixth transistor is electrically connected to the first node, and a second electrode of the sixth transistor is electrically connected to the write node;
and/or,
further comprising a second light-emitting control circuit,
wherein the reset node is electrically connected to the second terminal of the driving circuit through the second light-emitting control circuit; the reset node is electrically connected to a first electrode of the light-emitting element, and a second electrode of the light-emitting element is electrically connected to a low voltage line; and
a control terminal of the second light-emitting control circuit is electrically connected to a second light-emitting control line, and the second light-emitting control circuit is used for, under control of a second light-emitting control signal provided by the second light-emitting control line, controlling the reset node and the second terminal of the driving circuit to be connected or disconnected from each other; wherein the second light-emitting control circuit comprises a seventh transistor; and a gate electrode of the seventh transistor is electrically connected to the second light-emitting control line, a first electrode of the seventh transistor is electrically connected to the second terminal of the driving circuit, and a second electrode of the seventh transistor is electrically connected to the reset node; and/or,
wherein the first energy-storage circuit comprises a first capacitor, and the second energy-storage circuit comprises a second capacitor; the third reset circuit comprises a fifth transistor;
a first terminal of the first capacitor is electrically connected to the write node, and a second terminal of the first capacitor is electrically connected to the intermediate node;
a first terminal of the second capacitor is electrically connected to the intermediate node, and a second terminal of the second capacitor is electrically connected to the second terminal of the driving circuit; and
a gate electrode of the fifth transistor is electrically connected to the third reset control line, a first electrode of the fifth transistor is electrically connected to the reference voltage line, and a second electrode of the fifth transistor is electrically connected to the intermediate node.

9. (canceled)

10. The pixel circuit according to claim 5, wherein the driving circuit comprises a driving transistor, the first light-emitting control circuit comprises a first transistor, the data write circuit comprises a second transistor, the first reset circuit comprises a third transistor, and the second reset circuit comprises a fourth transistor;
a gate electrode of the driving transistor is electrically connected to the first node, a first electrode of the driving transistor is electrically connected to the first test node, and a second electrode of the driving transistor is electrically connected to the light-emitting element;
a gate electrode of the first transistor is electrically connected to the first light-emitting control line, a first electrode of the first transistor is electrically connected to the power voltage line, and a second electrode of the first transistor is electrically connected to the first electrode of the driving transistor;
a gate electrode of the second transistor is electrically connected to the scan line, a first electrode of the second transistor is electrically connected to the data line, and a second electrode of the second transistor is electrically connected to the write node;
a gate electrode of the third transistor is electrically connected to the first reset control line, a first electrode of the third transistor is electrically connected to the reference voltage line, and a second electrode of the third transistor is electrically connected to the first node; and
a gate electrode of the fourth transistor is electrically connected to the second reset control line, a first electrode of the fourth transistor is electrically connected to the initial voltage line, and a second electrode of the fourth transistor is electrically connected to the reset node.

11. The pixel circuit according to claim 6, wherein the first energy-storage circuit comprises a first capacitor, and the second energy-storage circuit comprises a second capacitor;
a first terminal of the first capacitor is electrically connected to the first node, and a second terminal of the first capacitor is electrically connected to the second terminal of the driving circuit; and
a first terminal of the second capacitor is electrically connected to the power voltage line, and a second terminal of the second capacitor is electrically connected to the second terminal of the driving circuit.

12.-14. (canceled)

15. A pixel circuit test method, applied to the pixel circuit according to claim 1, wherein the method comprises:
in a detection phase, providing a valid test control signal to the test control terminal, and controlling, by the test switch circuit under control of the test control signal, the first test terminal and the second test terminal to be connected to each other.

16. The pixel circuit test method according to claim 15, wherein the method further comprises:
in a display phase, providing an invalid test control signal to the test control terminal, controlling, by the test switch circuit under control of the test control signal, the first test terminal and the second test terminal to be disconnected from each other, and generating, by the pixel driving circuit, the drive current for driving the light-emitting element.

17. The pixel circuit test method according to claim 15, or wherein the pixel driving circuit comprises the driving circuit and a driving control circuit; and the method comprises:
in the detection phase, controlling, by the driving control circuit, the control terminal of the driving circuit and the first terminal of the driving circuit to be connected to each other.

18. A display apparatus, comprising the pixel circuit according to claim 1.

19. A display panel, comprising pixel circuits in a plurality of rows and a plurality of columns, a plurality of first direct current voltage lines, and a plurality of second direct current voltage lines, wherein the pixel circuits are disposed in a display area; the display panel further comprises a test switch module disposed in a bezel area; the test switch module comprises a plurality of test switch circuits; and
each of the test switch circuits is electrically connected to a test control terminal, one of the first direct current voltage lines, and one of the second direct current voltage lines, and is used for, under control of a test control signal provided by the test control terminal, controlling the first direct current voltage line and the second direct current voltage line to be connected or disconnected from each other.

20. The display panel according to claim 19, wherein the first direct current voltage lines and the second direct current voltage lines all extend in a first direction; the display panel comprises N rows of pixel circuits; the pixel circuits located in an n^{th} row are electrically connected to an n^{th} first direct current voltage line of the first direct current voltage lines and an n^{th} second direct current voltage line of the second direct current voltage lines; N is an integer greater than 1, and n is a positive integer less than or equal to N;
the test switch module comprises N test switch circuits; and
an n^{th} test switch circuit of the test switch circuits is electrically connected to an n^{th} test control terminal, the n^{th} first direct current voltage line, and the n^{th} second direct current voltage line, and is used for, under control of an n^{th} test control signal provided by the n^{th} test control terminal, controlling the n^{th} first direct current voltage line and the n^{th} second direct current voltage line to be connected or disconnected from each other.

21. The display panel according to claim 19, comprising N rows of pixel circuits, wherein the pixel circuits located in an n^{th} row are electrically connected to an n^{th} first direct current voltage line of the first direct current voltage lines and an n^{th} second direct current voltage line of the second direct current voltage lines; N is an integer greater than 1, and n is a positive integer less than or equal to N; m is a positive integer less than N;
the test switch module comprises at least one test switch circuit; and
an m^{th} test switch circuit of the test switch circuits is electrically connected to an m^{th} test control terminal, an m^{th} first direct current voltage line of the first direct current voltage lines, and an (m+1)^{th} second direct current voltage line of the second direct current voltage lines, and is used for, under control of an m^{th} test control signal provided by the m^{th} test control terminal, controlling the m^{th} first direct current voltage line and the (m+1)^{th} second direct current voltage line to be connected or disconnected from each other.

22. The display panel according to claim 19, wherein the first direct current voltage lines comprise a plurality of rows of first direct current voltage line portions and a plurality of columns of second direct current voltage line portions that are electrically connected to each other, and the second direct current voltage lines comprise a plurality of rows of third direct current voltage line portions and a plurality of columns of fourth direct current voltage line portions that are electrically connected to each other;
an extension direction of the first direct current voltage line portions is the same as an extension direction of the third direct current voltage line portions, an extension direction of the second direct current voltage line portions is the same as an extension direction of the fourth direct current voltage line portions, and the extension direction of the first direct current voltage line portions intersects the extension direction of the second direct current voltage line portions;
the test switch module comprises a plurality of first test switch circuits and a plurality of second test switch circuits;
each of the first test switch circuits is electrically connected to a corresponding test control terminal, one row of the first direct current voltage line portions, and one row of the third direct current voltage line portions, and is used for, under control of the test control signal provided by the test control terminal, controlling the row of the first direct current voltage line portions and the row of the third direct current voltage line portions to be connected or disconnected from each other; and
each of the second test switch circuits is electrically connected to a corresponding test control terminal, one column of the second direct current voltage line portions, and one column of the fourth direct current voltage line portions, and is used for, under control of the test control signal provided by the test control terminal, controlling the column of the second direct current voltage line portions and the column of the fourth direct current voltage line portions to be connected or disconnected from each other.

23. A display panel, comprising pixel circuits in a plurality of rows and A columns, a plurality of third direct current voltage lines, and data lines in A columns, wherein A is an integer greater than 1; a is a positive integer less than or equal to A; the pixel circuits are disposed in a display area; the pixel circuits located in an a^{th} column are electrically connected to the data line in the a^{th} column;
the display panel further comprises a test switch module disposed in a bezel area; the test switch module comprises A test switch circuits; and
an a^{th} test switch circuit of the test switch circuits is electrically connected to an a^{th} test control terminal, one of the third direct current voltage lines, and the data line in the a^{th} column, and is used for, under control of an a^{th} test control signal provided by the a^{th} test control terminal, controlling the third direct current voltage line and the data line in the a^{th} column to be connected or disconnected from each other.

24. A display apparatus, comprising the display panel according to claim 19.
